(19) United States
(12) Patent Application Publication
(10) Pub. No.: US 2017/0221146 A1
(43) Pub. Date: Aug. 3, 2017

(54) LIVE OPTIONS SEARCH BASED ON INPUT GREEKS AND THE RESPECTIVE TRADING

(71) Applicant: Raghuraman Ramachandran, Watford (GB)

(72) Inventor: Raghuraman Ramachandran, Watford (GB)

(21) Appl. No.: 15/418,722

(22) Filed: Jan. 28, 2017

Related U.S. Application Data
(60) Provisional application No. 62/288,678, filed on Jan. 29, 2016.

(51) Int. Cl. G06Q 40/04; G06F 17/30; G06Q 30/02

(52) U.S. Cl. CPC G06Q 40/04; G06Q 30/0201; G06F 17/30867

(57) ABSTRACT

Various embodiments include systems, devices, and/or methods for selecting potential trading strategies for users. Various embodiments include presenting potential trading strategies to users. The strategies may be selected based on Greek values associated with the respective strategies. The Greek values may represent values selected by a user or chosen to hedge securities currently controlled by the user. The user may be presented with strategies where such strategies are prominently represented by their associated Greek values. In various embodiments, Greek values for one or more derivatives or other securities are continuously calculated and updated in real time based on market data, and used to update strategies that are made available to a user.

### RELATED APPLICATIONS

The present application claims the benefit of priority of U.S. provisional patent application No. 62/288,678, entitled AD-HOC LIVE GREEK SEARCH, and filed Jan. 29, 2016, the entirety of which is hereby incorporated by reference herein for all purposes.

### BACKGROUND

Numerous financial products, securities, instruments, and/or other assets are bought and sold regularly. Examples include stocks, equities, bonds, government bonds, corporate bonds, treasuries, commodities, currencies, insurance policies, real estate, mortgages, indices, spiders, mutual funds, exchange traded funds, and so on.

Among the traded products are “derivatives”, which may constitute contracts related to one or more underlying securities. For example, a “call option” may give the option holder the right, for a limited period of time, to buy or “call” an underlying security at a specified price (the “strike price”). Thus, if the market price for the underlying security exceeds the strike price, the option holder can make a profit by exercising the option, purchasing the security at the strike price, and then selling the security again at the higher market price.

As the above example illustrates, a derivative (such as an option) has its own value that may be derived, at least in part, from the behaviour of the underlying security.

A derivative may also derive value from a fact or circumstance that is not strictly a security in the traditional sense. For example, a weather derivative may provide its holder with rights to a payment that is dependent on the average temperature for a month.

It will be appreciated that financial products and derivatives come in many forms and varieties, and the examples and illustrations described herein are not intended to be limiting with respect to the definitions of these concepts, nor to the applications of the embodiments described herein.

Since derivatives may depend for their value on one or more underlying securities, variables, or other factors, a market participant (e.g., a trader, e.g., a market maker) may be interested in the sensitivity of a derivative's value to changes in such factors. For example, a trader holding a call option may wish to know how much the value of his option will change for every dollar increase in the value of the underlying stock. As another example, the trader may wish to know how much the value of his option will change for every day of time that passes.

The sensitivity of a derivative's price to changes in underlying variables is often quantified in the form of “Greeks”. This is the collective name for different measures of sensitivity with respect to different underlying variables, where each such sensitivity is represented by a different, typically Greek letter.

A partial list of Greeks is defined herein, although the contemplated embodiments are not limited to only these.

As used herein, “Vega” may refer to the rate of change of a derivative's price with respect to changes in implied volatility of the underlying security.

As used herein, “Theta” may refer to the rate of change of a derivative's price with respect to time remaining until the option's expiration.

As used herein, “Delta” may refer to the rate of change of a derivative's price with respect to a change in price of the underlying security.

As used herein, “Gamma” may refer to the rate of change of Delta with respect to a change in price of the underlying security.

As used herein, “Rho” may refer to the rate of change of a derivative's price with respect to a change in interest rates.

Greeks can be computed for individual derivatives and/or for combinations of derivatives, including for entire portfolios or books. For example, the Vega of a combination of three derivatives may refer to the rate of change of the aggregate price of the three derivatives with respect to changes in implied volatility of an underlying security upon which each of the three derivatives depends. Because Greeks can be computed for entire portfolios, adding or removing a new derivative to/from the portfolio has effect of changing the Greeks for the entire portfolio.

When contemplating or performing a trade, some market participants frame their objectives in terms of achieving desired values for one or more Greeks. These Greeks may represent Greeks for the trade, or they may represent Greeks for a portfolio that would result after the trade. For example, a market participant may frame his objective for a trade as achieving a Vega of 0.01 for a purchased derivative. As another example, a market participant may frame his objective for a trade as achieving a Delta of 0.5 for his entire portfolio. It will be appreciated that, in various embodiments, market participants may frame their objectives for achieving various other values or combinations of values for Greeks.

Although market participants may frame their objectives in terms of Greeks, the values of Greeks are not necessarily readily discernible from the plain terms of a derivatives contract, nor from market data (e.g., bid/ask prices, purchase prices, sale prices, etc.) For instance, a trader contemplating the purchase of a call option on the S&P 500 index may have ready access to a second-by-second price history of the S&P 500, but not to a similar stream of Greek values for the call option.

The market participant may attempt to use market data to compute one or more Greeks. However, the process of performing these computations often requires the participant to manually select derivatives for evaluation, and manually select or copy market data for use in the computations. This is especially true if the participant has to compute Greeks for combinations of derivatives. The manual process not only requires effort that could be spent on other things, but also results in values for Greeks that are stale by the time they are computed.

### SUMMARY

Various embodiments include systems and methods for allowing a market participant to specify an objective for a trade in terms of achieving desired values for one or more Greeks. The objective may include an objective for the market participant and/or for a portfolio. The system may then use real-time market data to compute a trade that, if executed, would achieve the desired value(s) for the Greeks. The market participant may then approve the trade, after which the system may carry out the trade.

### BRIEF DESCRIPTION OF THE DRAWINGS

FIG. 1 provides an illustration of a system, according to some embodiments.

FIG. 2 provides an illustration of a system information flow, according to some embodiments.

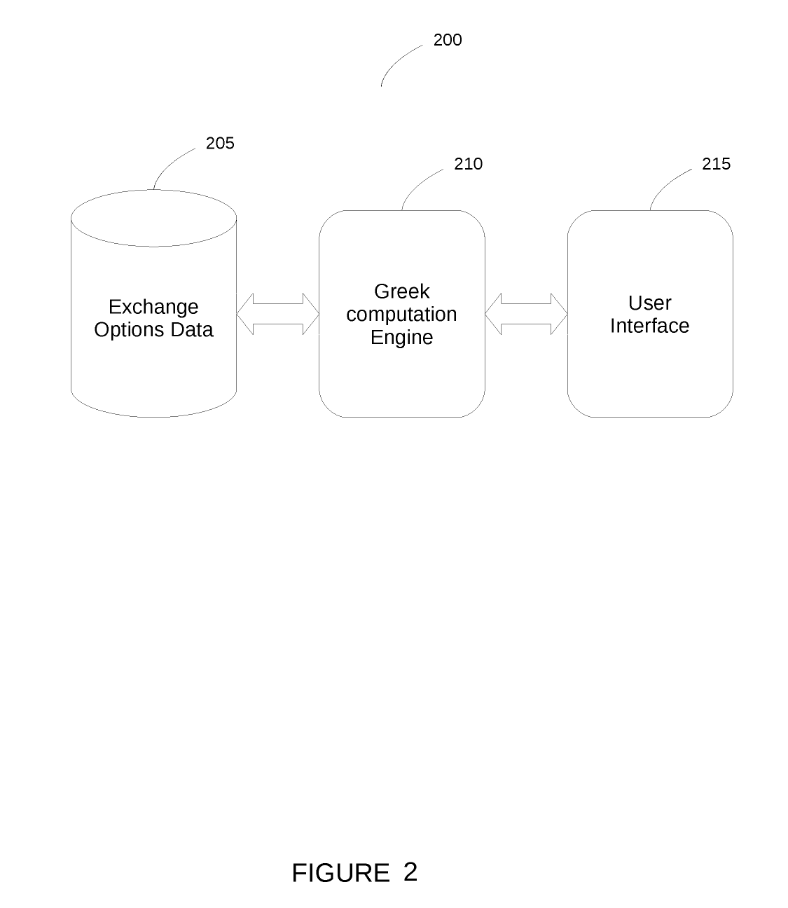

FIG. 3 provides an illustration of a process flow, according to some embodiments.

FIG. 4 provides an illustration of a system, according to some embodiments.

FIG. 5 provides an illustration of a Graphical User Interface, according to some embodiments.

FIG. 6 provides an illustration of a Graphical User Interface, according to some embodiments.

FIG. 7 provides an illustration of a Graphical User Interface, according to some embodiments.

FIG. 8 provides an illustration of a Graphical User Interface, according to some embodiments.

FIG. 9 provides an illustration of a Graphical User Interface, according to some embodiments.

FIG. 10 provides an illustration of a Graphical User Interface, according to some embodiments.

FIG. 11 provides an illustration of a Graphical User Interface, according to some embodiments.

FIG. 12 provides an illustration of a Graphical User Interface, according to some embodiments.

FIG. 13 provides an illustration of a Graphical User Interface, according to some embodiments.

FIG. 14 provides an illustration of a Graphical User Interface, according to some embodiments.

FIG. 15 provides an illustration of a Graphical User Interface, according to some embodiments.

FIG. 16 provides an illustration of a Graphical User Interface, according to some embodiments.

FIG. 17 provides an illustration of a Graphical User Interface, according to some embodiments.

### DETAILED DESCRIPTION

As used herein, references to devices, servers, storage devices, etc., may include single physical devices or may include devices with multiple separate physical components, or to devices which are instantiated virtually. For example, a server may refer to a single physical device, to a distributed system comprising multiple separated physical components, or to a virtual server residing in software and not tied to any particular hardware device or system. A server may include a cloud server, for example.

As described herein, communication between devices may occur via any suitable means, including via landline or wireless communication, via the Internet, via telephonic networks, via cellular networks, via satellite communication, via cable, via fiber optic, via local area network, via wide-area network, or via any other means.

According to some views, a derivatives market may contain two types of participants. One type of participant includes directional derivatives traders (e.g., options traders) and directional hedgers. These are participants who buy and sell options purely to enjoy the benefits of their expectations on the underlying securities upon which these options are built. In other words, these participants hope to benefit by accurately predicting the price movement (or direction of price movement) of the underlying securities.

A second type of participant includes bookmakers and others who provide liquidity on these derivatives. The second type of participant does not necessarily have a view or prediction as to which way the underlying security will move. Rather, the second type of participant makes a market in the derivative (e.g., is willing to either buy or sell) so that one or more of the first type of participant can have a ready counter-party. The second type of participant may make a profit based on the difference or spread between the price at which it buys and the price at which it sells the derivative.

This second type of participant, (e.g., liquidity provider, bookmaker) is more interested in managing its risks than in taking a directional view on the underlying security. The liquidity provider does not want to suffer losses if the underlying moves in either direction.

Traditional trading systems are more geared to the first type of participant in that such systems clearly display information about derivatives that makes it obvious how the derivative will perform in response to movements in the underlying security. For example, with a derivative listed as a “call” option with a particular strike price, it is obvious that the derivative will increase in value with an increase in value of the underlying security, and further that the derivative will be “in the money” once the price of the underlying has exceeded the strike price.

However, traditional trading systems do not readily cater towards the second type of market participant in that they do not make it obvious how to reduce or mitigate risk when describing derivatives that are available to be traded. As mentioned, the second type of market participant may be less concerned with the effects of a directional movement of the underlying security, and more concerned with eliminating potential risks inherent in any movement.

Various embodiments present information to market participants (e.g., to the second type of market participant) in such a way as to make it clearer as to how to reduce or mitigate risk.

Various embodiments, when used by one or more parties (e.g., by multiple parties; e.g., by a significant fraction of participants in a market; e.g., by a significant fraction of major participants in a market) may have a beneficial system-wide or societal effect. Various embodiments allow users/market participants to be more readily aware of the risks they are bearing. Various embodiments allow users/market participants to more easily manage, hedge, or otherwise reduce their risk exposures. When a significant number of market participants are able to maintain better awareness of the risks they are taking, and to manage such risks, then the overall market, system (e.g., financial system), etc., may be less prone to shocks, crashes, freezes, or other problems. This may accordingly confer a benefit to society as a whole, including anyone who might be affected by market crashes.

Various embodiments allow a user to participate in a market with greater anonymity than is conventionally possible. In various embodiments, a user can determine (e.g., discover) pricing information for one or more derivatives. The user may determine pricing information directly from a system according to various embodiments. The user may thereby avoid having to request pricing information (e.g., a quote) from another party, such as from a broker. If a user were to request pricing information from another party, than the user's intention could potentially be inferred by the other party. For example, the other party could infer that the user wishes to buy or sell the derivative in question. As another example, the other party could infer the position of the user (e.g., derivatives or other securities controlled by the user). In such a case, the other party, an affiliate of the other party, or a third party informed by the other party could profit from this knowledge, to the possible detriment of the user. For example, the other party could purchase a derivative desired by the user, thereby driving up the price of the derivative before the user can buy it. As another example, the other party could disclose the user's inquiry in a public forum, which may likewise serve to drive up, or down as the case may be, the price of the derivative.

In various embodiments, a user may benefit from more rapid price discovery than is conventionally possible. For example, rather than taking the time to ask another party (e.g., a broker) for a price quote, a user may receive real-time market data feeds that incorporate pricing information.

### System

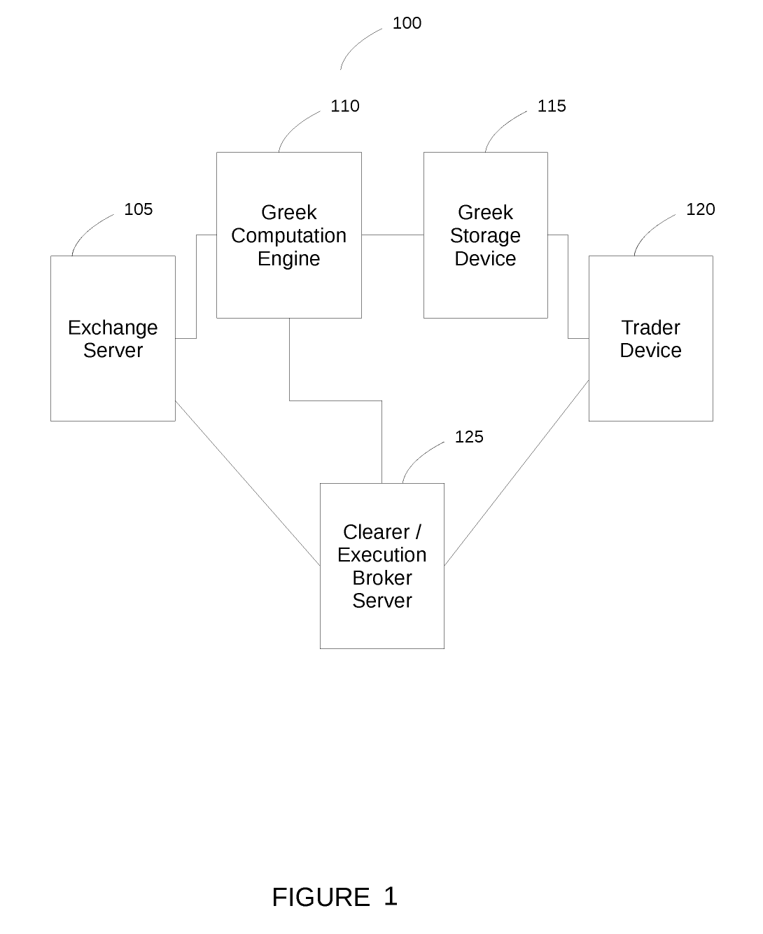

With reference to FIG. 1, a system 100 is shown according to some embodiments. An exchange server 105 may be associated with an exchange, financial exchange, market, or the like. The exchange may bring together market participants who may buy and sell one or more products (e.g., financial products, stocks, bonds, commodities, etc.).

The exchange may receive bid prices and product quantities from prospective buyers, and the exchange may also receive ask prices and product quantities from prospective sellers. The exchange may facilitate the matching of buyers and sellers who are willing to transact at a common price for a given quantity of product. The exchange may facilitate the transaction. The exchange may also record data related to bids, asks, and filled transactions. Such data may include, without limitation, products (e.g., the name and/or identifier of a security), prices, and quantities. Data may also include times at which bids, asks, and sales take place. Data may further include identities of one or more market participants (e.g., the identities of one or more parties to a transaction). As will be appreciated, the exchange may receive other types of input from market participants, and may record other types of data, all of which are contemplated by various embodiments.

In various embodiments, the exchange server 105 may be in communication with a Greek Computation Engine 110. The engine 110 may receive market data (such as real-time market data) from the exchange server 105. In various embodiments, engine 110 may receive data (such as real-time data) from another source as well, such as from other exchanges, from individual market participants, etc. Data may be received in various formats, such as in XML, JSON, a proprietary format, or in any other format. Data may be encrypted, or plaintext.

The engine 110 may be embodied as a server, such as a cloud server. The engine may be remote from exchange server, or may be co-located, according to various embodiments.

The engine 110 may include one or more algorithms for computing one or more Greeks. The engine 110 may include one or more algorithms for computing, in real-time or in substantially real-time, one or more Greeks. The algorithms may use received market data (e.g., received from exchange server 105) to compute the Greeks. Greeks may change over time. Thus, engine 110 may repeatedly re-compute Greeks as new market data is received. So that market participants (e.g., traders, market makers) may make rapid decisions based on the most up-to-date values for the Greeks, it may be beneficial that computation of the Greeks by engine 110 occurs as quickly as possible. It may be beneficial that computation of the Greeks by engine 110 occurs in real time. In various embodiments, the time to re-compute a Greek based on new data, new market data, and/or based on the passage of time, may be in the order of milliseconds. However, various embodiments contemplate that computation times could be faster or slower as well.

The engine 110 may be in communication with a Greek Storage Device 115. The Greek Storage Device 115 may be a server, database, or any other suitable device. The Greek Storage Device 115 may store the results of computations made by the Greek Computation Engine 110, and may thus store Greeks computed for one or more securities (e.g., derivative securities). Device 115 may or may not be a separate device from engine 110, in various embodiments. In various embodiments, engine 110 and Device 115 may be co-located, proximate, or remote from one another.

The Greek Storage Device 115 may be in communication with a Trader Device 120. The Trader Device 120 may include any suitable device for use by a trader, market maker, and/or by any other market participant. Such devices may include a workstation, computer, personal computer, laptop, mobile device, tablet, smartphone, or other device.

The Trader Device 120 may receive information about computed Greek values from the Greek Storage Device 115. The Trader Device may display this information for a trader, e.g., via a graphical user interface. The Trader Device may also aggregate, filter, or otherwise modify information received from the Greek Storage Device for display to the trader.

A trader may determine a trade he/she wishes to execute, and may enter instructions into the Trading Device 120 to place the trade. The Trading Device 120 may be in communication with a Clearer/Execution Broker Server 125. The Server 125 may be associated with a Clearer and/or Broker, which may perform such functions as placing a trade on an exchange on behalf of the trader, assuming counter-party risk for the trader, assuming counter-party risk for parties transacting with the trader, receiving collateral deposits from the trader (and/or from other parties), etc.

The Server 125 may receive information about trades that have been requested by the trader. The Clearer/Execution Broker Server 125 may itself be in communication with Exchange Server 105, and may place the trade with the Exchange Server on behalf of the trader.

The Clearer/Execution Broker Server 125 may also be in communication with the Greek Computation Engine 110. The Server 125 may provide information to the Engine 110, which may be used by Engine 110 to compute or aid in computation of values for one or more Greeks. For example, the Server 125 may relay a bid or ask price named by the Trader to the Engine 110, and the Engine 110 may use the price to compute values for one or more Greeks associated with the derivative(s) being traded.

### GUI

Various embodiments may include a graphical user interface (GUI) for use by the trader. The GUI may be displayed on the Trader device. The GUI may be interactive. The GUI may include buttons, fields, regions, etc., that can be activated with touch, with mouse clicks, with drags, with double clicks, and/or with any other suitable means. The GUI may further display information, including information in the form of text, graphics, graphs, or in any other form.

In various embodiments, the GUI may be rendered using a browser, using a Java program, using Visual Basic, or using any other suitable programming language.

In various embodiments, the GUI may display information about one or more derivatives. Information may include a name of the derivative, a type of the derivative (e.g., “call”, “put”), pertinent contractual terms associated with the derivative (e.g., strike price, expiration date, underlying security, etc.), and any other pertinent information. Information may include historical data, such as historical prices, historical bids and asks, historical prices for the underlying, and any other data relevant to the derivative. Information may include data related to variables that may influence the derivative's price, such as data about prevailing interest rates.

In various embodiments, the GUI may display calculated, computed, or otherwise derived values relevant to the derivative. For example, such values might be computed based on mathematical pricing models for the derivative. Values may include a computed price, and/or one or more computed Greek values.

In various embodiments, the GUI may display aggregate or summary information related to two or more derivatives (e.g., to a combination of derivatives, basket of derivatives, to a portfolio of derivatives, etc.). Aggregate information might include, for example, a value of a Greek for an entire portfolio.

According to various embodiments, a trader may use the GUI to enter instructions for placing a trade of one or more derivatives. Instructions may designate one or more derivatives, whether to buy or to sell, a price at which a transaction is desired, and/or any other pertinent information. Instructions may specify a type of order, such as market order, limit order, expiring order, or any other type of order.

In various embodiments, the GUI may represent a derivative in terms of a value of a Greek associated with the derivative. For example, the GUI may represent a particular option as “Delta 0.5” or as “Theta −0.1”. Such numerical values may be literally displayed for a derivative, in various embodiments. In some embodiments, numeric values may be represented in terms of gradations of color, in terms of the size of a display region, in terms of the height of a display region, in terms of the position of a hand on an image of a dial, or in any other fashion, as will be appreciated.

In various embodiments, the representation of a derivative in terms of its Greek value is the primary representation of such derivative within the GUI. Thus, for example, a trader may see a representation of “Delta 0.5” to the exclusion of a more traditional representation, such as “Call, Strike 50, Expiration June 1”. In some embodiments, both a representation in terms of a Greek value, and a more traditional representation may be displayed. In some embodiments, where both a representation in terms of a Greek value, and a traditional representation are displayed, the former may have more prominence (e.g., greater size, bolder color, earlier position on the screen, etc.).

In various embodiments, a trader may advantageously utilize the Greek representation of a derivative, if he frames his goals for a trade in terms of achievement of a certain Greek value. For instance, if a trader wishes to place a trade which achieves a Delta of 0.5, the trader, need not scan through traditional representations of a derivative and calculate the Delta for each. Rather, the Delta value for a derivative will be evident from the outset.

In various embodiments, the GUI may represent a derivative in terms of a value of two or more Greeks associated with the derivative. For example, a derivative may be represented in terms of its Delta and Vega values.

In various embodiments, the GUI may represent a combination of derivatives in terms of a value of a Greek associated with the combination. For example, the GUI may represent a basket of five derivatives using a single Delta value.

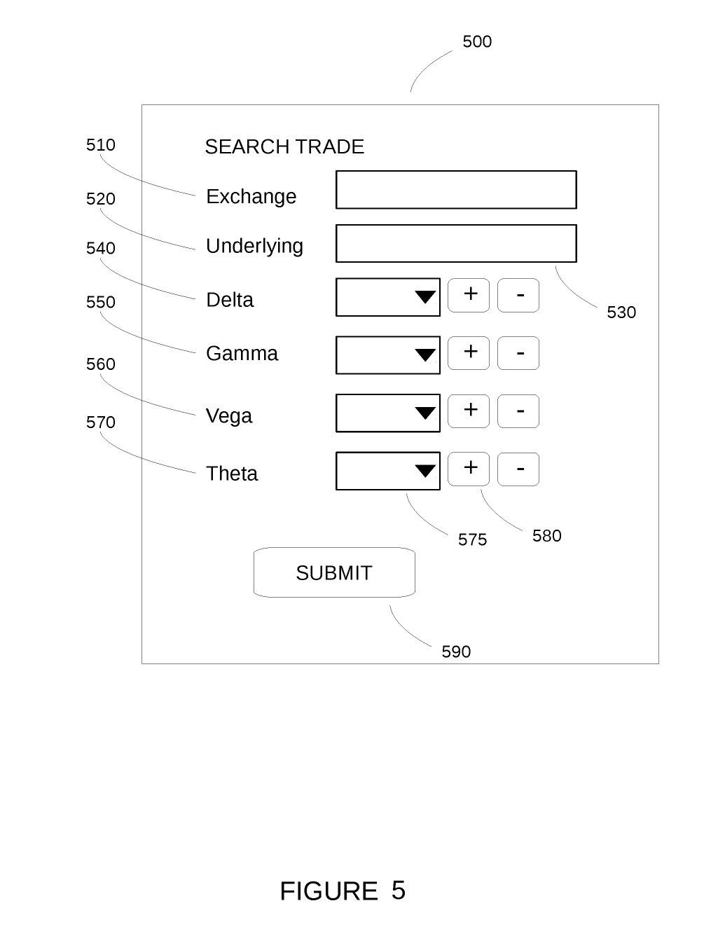

With reference to FIG. 5, a screen 500 from an illustrative GUI is shown according to some embodiments. Screen 500 may represent a search screen and/or dashboard. As will be appreciated, screen 500, and any other screens depicted herein, may appear as its own screen, and/or as a portion of a larger screen. In some embodiments screen 500 may be divided across two or more screens. For instance, elements of screen 500 may be spread across two or more screens.

With continuing reference to the GUI, the user may have the ability to input the Exchange at 510, the underlying (e.g., underlying security) at 520, and the intended Greeks that he/she wishes to search for in the market. A value for “Delta” may be entered at 540, a value for “Gamma” at 550, a value for “Vega” at 560, and a value for “Theta” at 570. In various embodiments, boxes, such as box 530, may permit text entry. In various embodiments, boxes such as box 575 may permit entry by drop-down menu. In various embodiments, the user may increment or decrement entries using “+” or “−” buttons as depicted at 580.

In various embodiments, the “+” or “−” boxes at 580 may be indicators. The “+” indicator may light or otherwise highlight when the user has entered a positive value, while the “−” indicator may light when the user has entered a negative value. This may make it less likely that a user enters a value with an unintended sign.

As will be appreciated, more entry boxes may be used to receive user inputs for additional Greeks and/or for additional parameters. In various embodiments, the user may have the ability to enter fewer parameters.

In various embodiments, this screen is an interface to a ‘live’ search engine, meaning that this would be connected to the markets on a live basis and will search for the desired trades on a real-time basis.

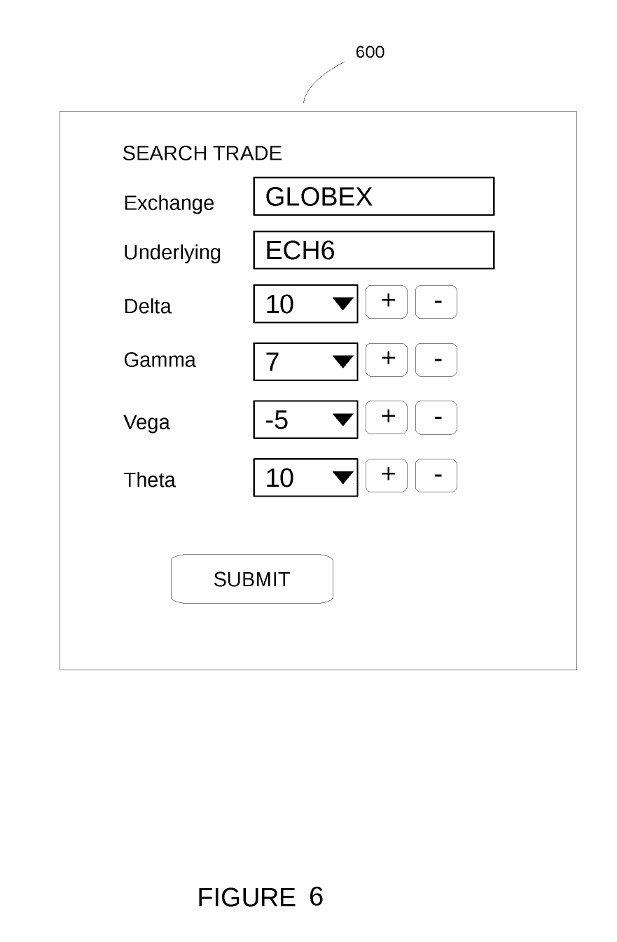

With reference to FIG. 6, a screen 600 from an illustrative GUI is shown according to some embodiments. Screen 600 may represent the same screen as 500 once values have been entered by a user. Although screen 600 depicts all fields having been populated, some embodiments contemplate that a user may perform a search with fewer than all fields populated. In FIG. 6, the user has indicated a desire to search for option strategies whose net Delta would be 10, Gamma would be 7, Vega would be −5 and Theta would be 10. In various embodiments, the units of these Greeks would be contextual to the underlying market and would change for each market. In various embodiments, the units may or may not be shown.

In various embodiments, the user would have the ability to choose how he/she wishes to see Gamma, Vega or Delta. It could be dollar-based it could be notional/size based, or it could be in any other suitable format.

In FIG. 6, the user has entered values for four Greeks. However, in various embodiments, a user need not enter values for four Greeks, but may enter values for fewer than four Greeks (e.g., any subset or combination of the four Greeks). In various embodiments, a user can enter values for more than four Greeks. In various embodiments, a user may enter values for other criteria, or otherwise indicate other criteria. Any such values or criteria entered by the user may serve to define or limit the Search results presented to the user, as will be appreciated.

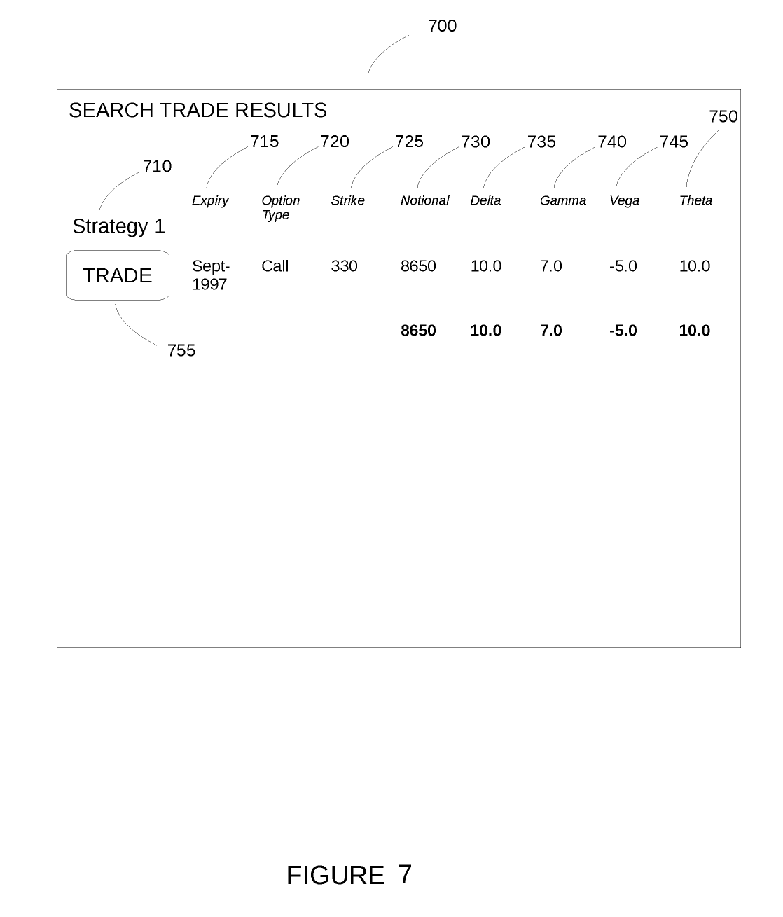

FIG. 7 depicts a screen 700 with a search result based on criteria entered by the user. In this case, there is a single search result (i.e., “Strategy 1” 710). The search result indicates details about a security (e.g., about a derivative security) that satisfies the user search criteria. These include an expiration date at 715, an option type at 720 (e.g., “call” or “put”), a strike price at 725, a notional value at 730, a Delta at 735, a Gamma at 740, a Vega at 745, and a Theta at 750. In some embodiments, the search result may indicate the quantity of such security that would need to be traded to satisfy the criteria entered by the user. In some embodiments, the quantity may equivalently be represented by the notional value (e.g., the quantity may be proportional to the notional value). In various embodiments, the notional value represents the value of an underlying security to which a derivative holder has rights (e.g., if the derivative gives the holder rights to buy 100 of the underlying security, then the notional value may be 100). The search result also indicates a notional value and values for the Greeks that correspond to this trade. However, in various embodiments, acceptable matches may deviate from user criteria by a predetermined amount, percentage, and/or by any other factor. Also, in various embodiments, further information may be indicated about the security or securities in a given strategy. In various embodiments, less information may be indicated about the security or securities in given strategy.

If the user wishes to employ a depicted strategy (e.g., “Strategy 1” on screen 700), then the user may activate (e.g., click or press) the “Trade” button 755.

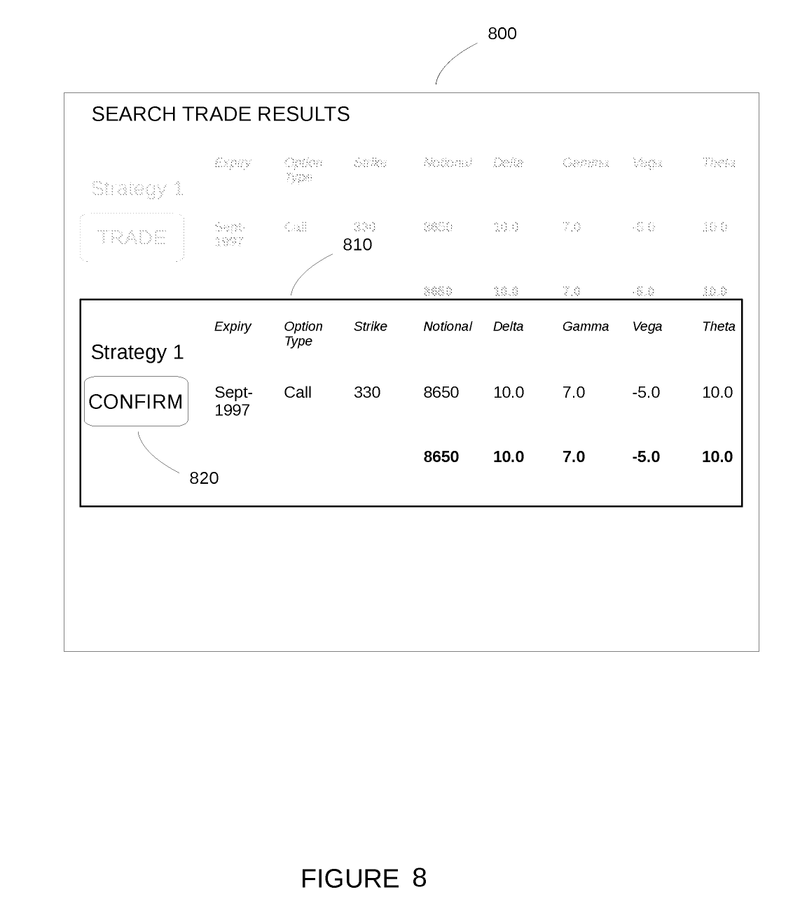

With reference to FIG. 8, a screen 800 from an illustrative GUI is shown according to some embodiments. A user who has selected “Strategy 1” in FIG. 7 (i.e., by clicking “Trade” under “Strategy 1”) may reach the screen 800 of FIG. 8. Here, the user may be asked to confirm the user's desire to execute the trade, e.g., by pressing the “Confirm” button 820. The user may be shown details about the trade, e.g., within a window 810. The original listing of potential strategies may remain (e.g., grayed out) in the background. Thus, if the user decides not to confirm the trade and proceed with the selected strategy, the user may return to the listing of strategies. If the user clicks “Confirm” 820, then the system may proceed to carry out the trade.

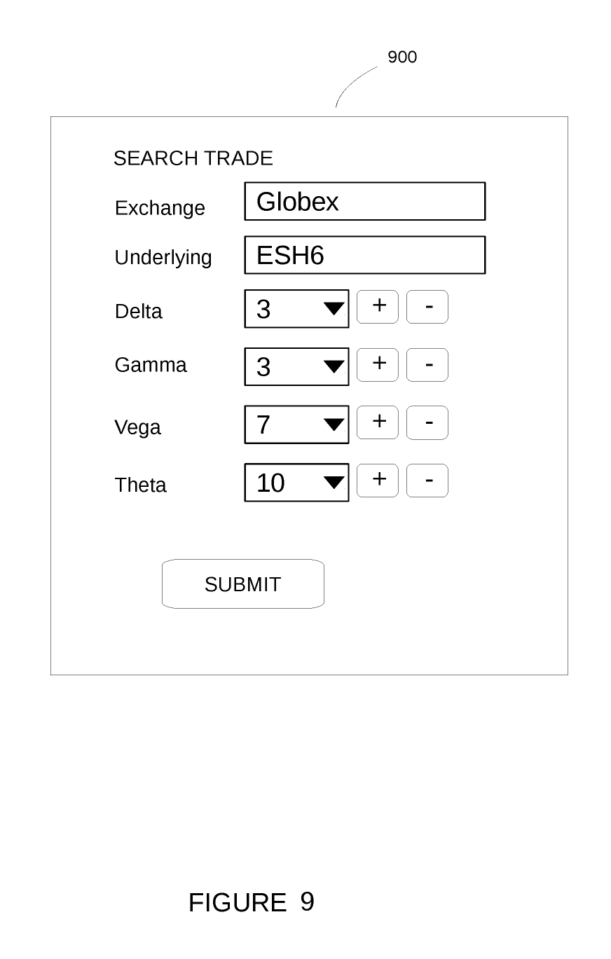

With reference to FIG. 9, a screen 900 from an illustrative GUI is shown according to some embodiments. As depicted, the user has entered different criteria from those entered in FIG. 6.

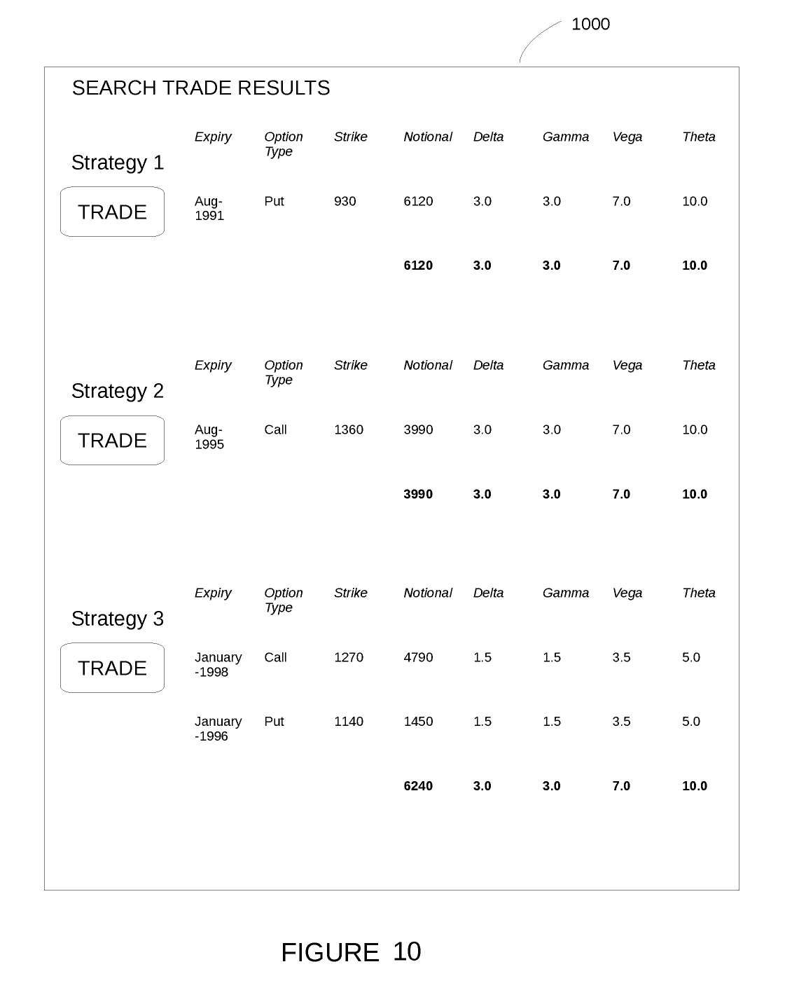

With reference to FIG. 10, a screen 1000 from an illustrative GUI is shown according to some embodiments. A number of different strategies have been returned that match the user criteria (e.g., as entered in screen 900). Strategies 1 and 2 each involve only a single security. However, strategy 3 involves two securities. Thus, if the user selects strategy 3, he will be authorizing the trade of both securities. By trading both securities, the user will achieve a combined set of Greek values for the trade that match his desired criteria.

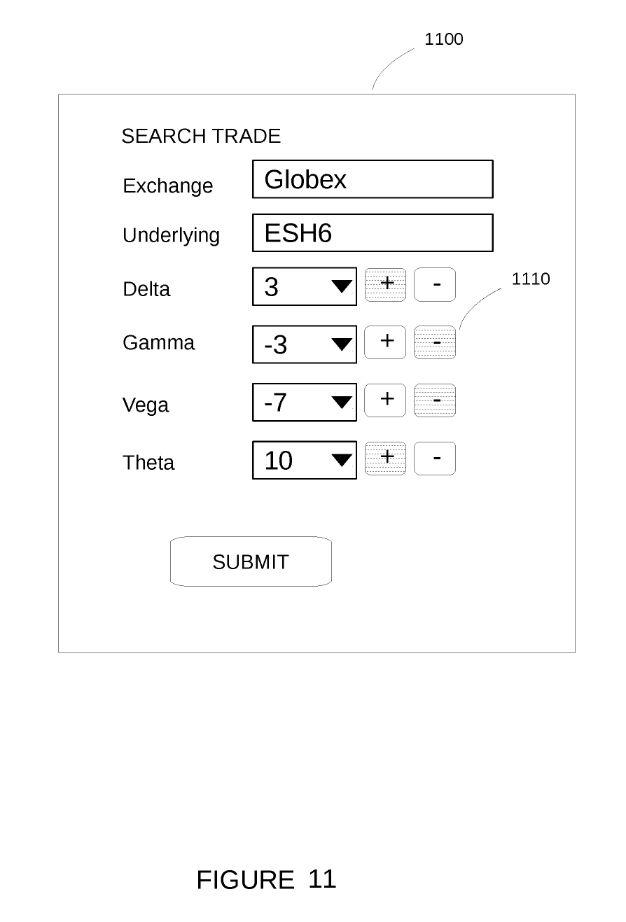

With reference to FIG. 11, a screen from an illustrative GUI is shown according to some embodiments. Here, the user has entered negative values for two of the Greeks (i.e., for Gamma and for Delta). In various embodiments, the GUI may highlight different regions or otherwise alert the user in a prominent way as to the fact that he has entered a negative value for a criterion. As depicted, when the user enters a negative value, a box with a minus sign (i.e., box 1110) is highlighted. In various embodiments, a box with a plus sign may be highlighted when the corresponding value entered by the user is positive. This may help the user to avoid inadvertently entering or missing the presence of a minus sign for his entered criteria.

In various embodiments, the GUI may provide messages, flags, alerts, warnings, etc., for any values the user enters that are deemed unusual, potentially mistaken, etc. For example, if the user enters a value for a Greek that is more than 200% of any such values previously entered, the GUI may provide an alert to the user. As will be appreciated, various other criteria may be used to show an alert.

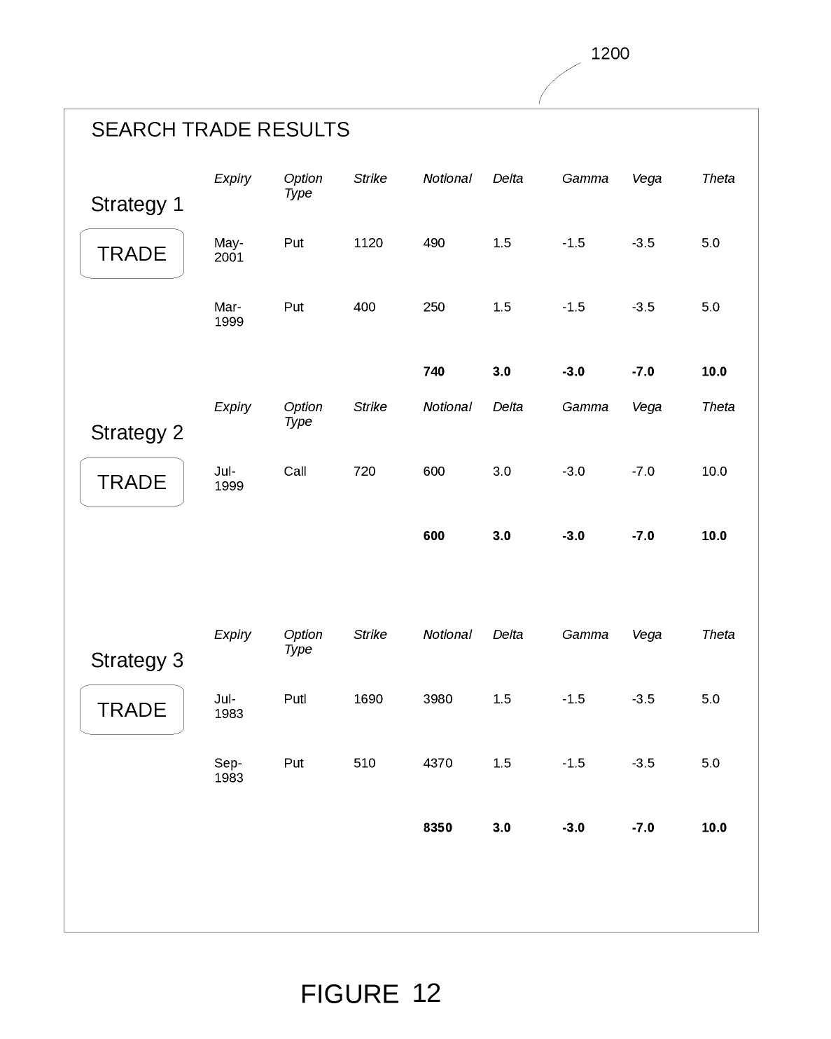

With reference to FIG. 12, a screen 1200 from an illustrative GUI is shown according to some embodiments. The screen 1200 shows strategies that have been returned based on the user's search criteria entered in screen 1100.

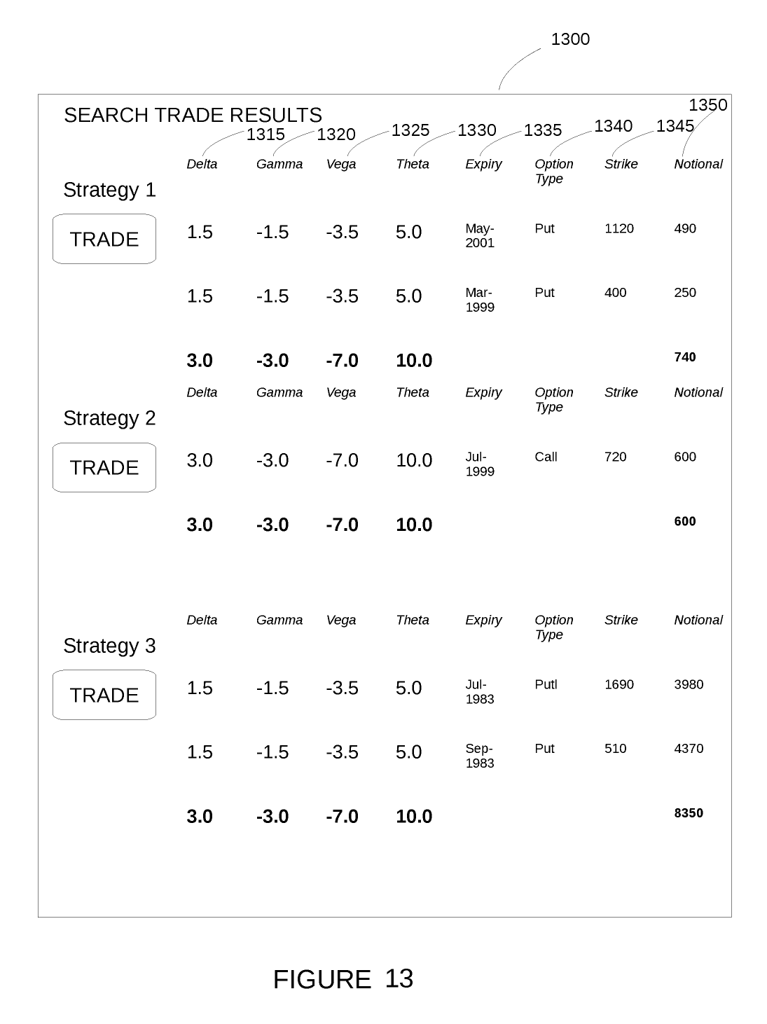

With reference to FIG. 13, a screen 1300 from an illustrative GUI is shown according to some embodiments. The screen 1300 shows strategies that have been returned based on the user's search criteria entered in screen 1100. Screen 1300 may represent a different arrangement of information than that depicted in screen 1200. At screen 1300, securities are represented most prominently in terms of their Greek values. The leftmost fields include “Delta” at 1315, “Gamma” at 1320, “Vega” at 1325, and “Theta” at 1330. As will be appreciated, the Greek fields may be depicted in a different order. Thus, a market participant who thinks in terms of Greek values for securities may readily peruse the Greek values for each security.

As depicted, screen 1300 may also show more traditional contractual terms for the derivatives. Additional fields may include an expiration date, or “Expiry” at 1335, an “Option Type” at 1340, a strike price or “Strike” at 1345, and a “Notional” value at 1350. As depicted, the Greek values are shown in a larger font than are the more traditional contractual terms associated with the derivatives. As will be appreciated, there may be various other ways of prominently showing Greek values for derivatives.

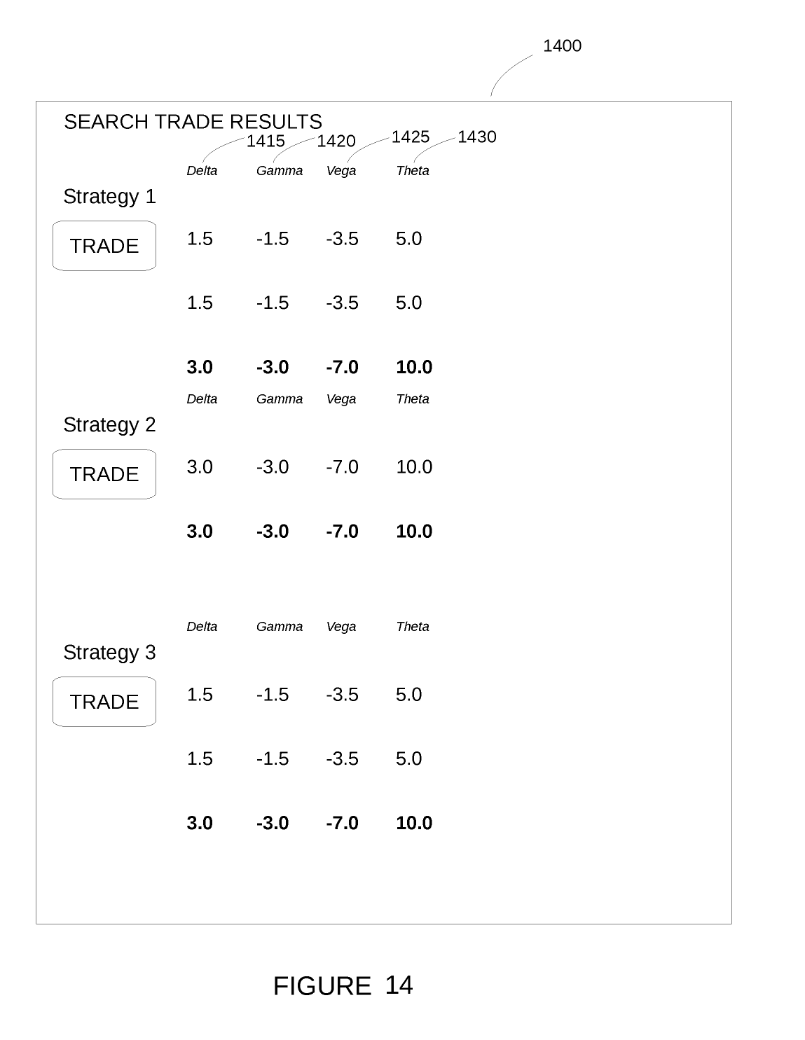

With reference to FIG. 14, a screen 1400 from an illustrative GUI is shown according to some embodiments. The screen 1400 shows strategies that have been returned based on the user's search criteria entered in screen 1100. When compared to screen 1300, screen 1400 dispenses with traditional contractual terms (e.g., “strike price”). Screen 1400 shows only the Greek values for the securities. These are shown as “Delta” at field 1415, “Gamma” at field 1420, “Vega” at 1425, and “Theta” at 1430.

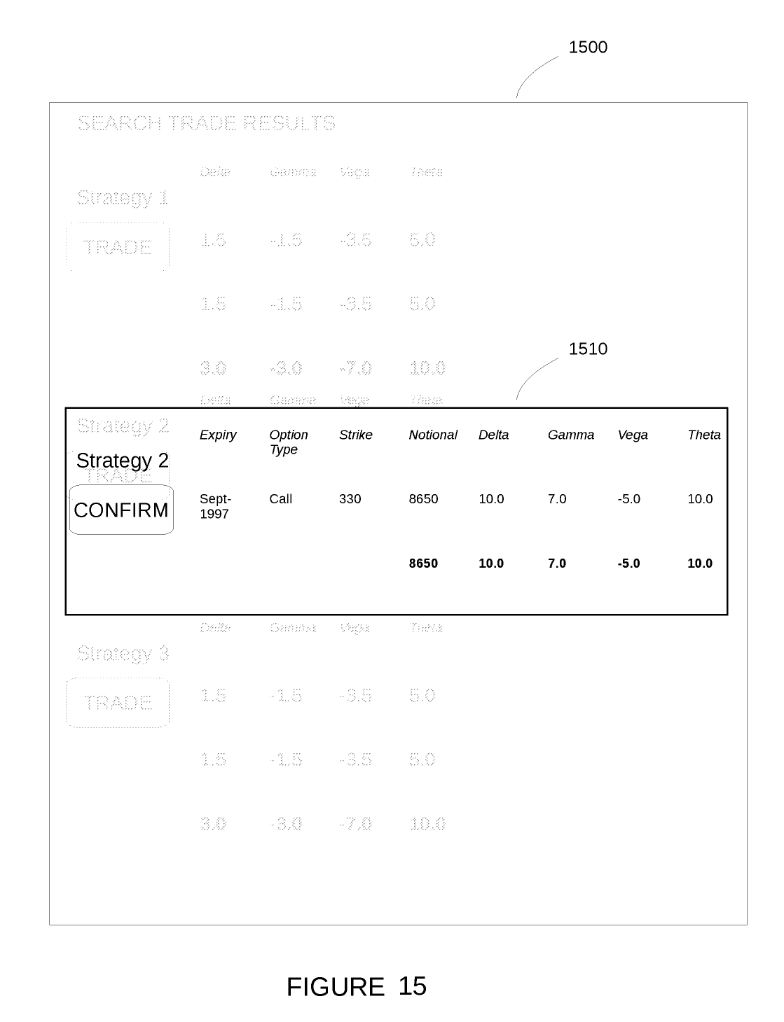

With reference to FIG. 15, a screen 1500 is shown according to some embodiments. This may represent screen 1400 in which an additional confirmation window 1510 is presented to a user who has selected “Strategy 2” on screen 1400. Whereas screen 1400 depicted only Greek values, the confirmation window depicts additional contractual terms associated with the selected security(ies). Thus, a user may have the opportunity to see the exact terms of securities he will trade rather than only derived Greek values. As will be appreciated, in various embodiments, a confirmation window may show different information, different arrangements of information, more information, or less information.

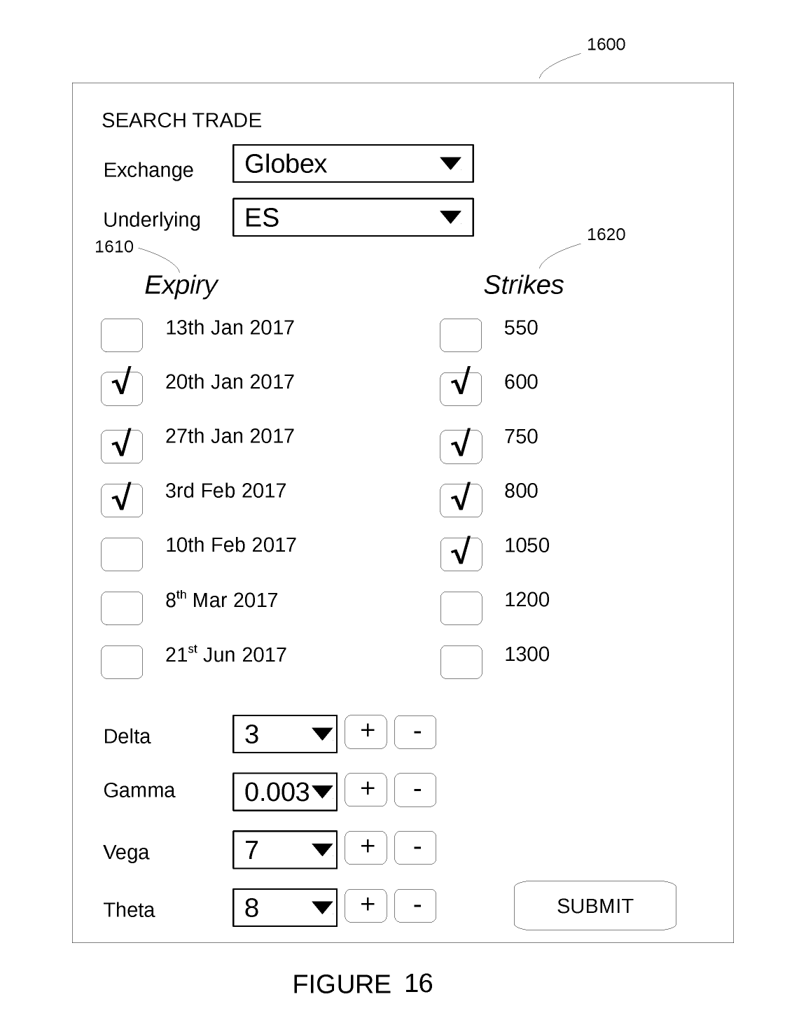

With reference to FIG. 16, a screen 1600 from an illustrative GUI is shown according to some embodiments. Screen 1600 may represent a search screen and/or dashboard. Screen 1600, as compared to screen 500, may include additional search options. These may include options for a user to search by expiration date (field 1610), and strikes (1620). For example, by checking certain boxes, the user may indicate that he wishes to search for derivatives with particular expiration dates and/or with particular strike prices. Any subsequent listing of strategies may include only derivatives matching the indicated criteria with respect to expiration date and strike prices.

Various embodiments present to a user derivatives, combinations of derivatives, strategies, and/or trades in terms of the Greek values of such derivatives, combinations, strategies, or trades. In various embodiments, derivatives, combinations of derivatives, strategies, and/or trades may be presented to a user in terms of the Greek values that the user's portfolio or other holdings will have after such derivatives etc., are traded. For example, the system may present a candidate strategy to a user. Associated with that strategy, the system may present to the user one or more Greek values that would represent the Greek values of the user's portfolio in the event that the strategy were to be implemented. In this case, a user may, for example, seek out strategies with associated Greek values that are close to zero, because implementing such strategies may bring down the risks of the user's overall portfolio.

In various embodiments, the system receives input from the user, a user device, a user's broker, or other party, where such input indicates securities that exist in a user's portfolio. In various embodiments, the system may receive input indicating the current Greek values of a user's existing portfolio. The system may then be able to determine the effect of any given strategy on the user's overall portfolio. For example, knowing the current Greek values associated with a user's portfolio, the system may add the Greek values associated with derivatives in a candidate trading strategy in order to determine what the effect would be on the portfolio should the strategy be implemented (i.e., should the trades in the strategy be executed).

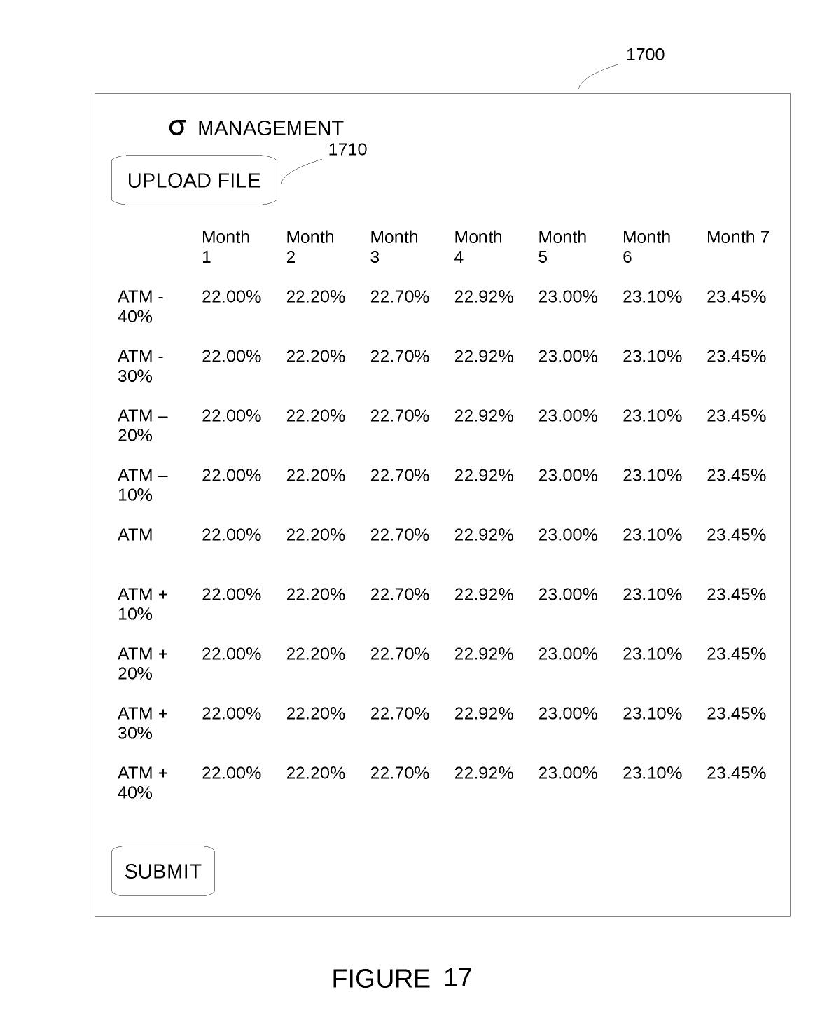

With reference to FIG. 17, a screen 1700 from an illustrative GUI is shown according to some embodiments. The screen shows a table with volatility depicted as a function of option strike price and expiration date. Illustrated volatilities may represent implied volatilities. These may be calculated using a standard formula, via a user-defined formula, or in any other fashion. The volatilities may be explicitly provided by the user. For example, the user may submit (e.g., via a spreadsheet) a table of volatilities. The user may upload such a table via “Upload File” button 1710, in some embodiments.

In various embodiments, a user may wish to view various volatility values to make sure they are acceptable, in keeping with his views, in keeping with his models, etc. The values used for one or more volatilities may impact (e.g., significantly impact) the values determined or calculated for one or more Greeks. Thus, if a user does not agree with volatility values used, he may not agree with resultant Greek values that are associated with possible trading strategies. This may lead to undesired trades. Accordingly, the user may wish to periodically view a screen, such as screen 1700, to monitor the values of volatilities being used to calculate Greek values.

In various embodiments, an ad-hoc/Live analytical search engine uses advanced mathematics to prune down a set of trades from a universe of many trades that would constitute the trades the user would have wished for. The user also would have a choice to restrict his searches based on his business requirements. For example, a market-maker may wish to trade only a maximum of 3 legs in any option strategy to reduce his brokerage cost and therefore he will get a customised search engine that will reduce the options to those having a maximum of 3 legs. A hedge fund volatility trader may not think along these lines because brokerage may not be his main concern. Rather, the hedge fund may be looking for a large Alpha (i.e., a large excess return or return above a given benchmark) and therefore he could choose to modify the search engine in some other possible way. Thus, as will be appreciated, various embodiments contemplate that criteria for specifying trades may be customizable by users and/or customized for individual users.

As will be appreciated, the GUI screens depicted herein are illustrative of some embodiments, but various embodiments are not so limited to the depictions in the drawings. It will be understood that various embodiments contemplate any suitable ordering, sizing, coloring, or arrangement of elements, fields, screens, tables, displayed information, prompts, buttons, entry boxes, menus, drop-down menus, icons, panes, headings, titles, windows, and so on. Various embodiments contemplate alternative wordings for prompts, messages, headings, and the like. Various embodiments contemplate that text could be in any suitable language. Various embodiments contemplate that more items or fewer items could be shown. For example, in various embodiments, a user may have more or fewer fields by which to search.

### Computing the Greeks

In various embodiments, Greeks may be computed through the use of various derivative pricing models. Models may include: (a) Black; (b) Black-Scholes; (c) Cox-Rubenstein; (d) Garman-Kohlhagen; (e) Implicit Finite Difference; (f) Roll-Geske-Whaley, or any other model. Models may include analytic models or numeric models. Models may be used in conjunction with computation of any appropriate partial derivatives, partial differences, or any other function in order to arrive at values for desired Greeks.

Computational methods may be employed as described in: (a) United States Patent Application 20150356682, entitled “Automated Trading System in an Electronic Exchange” and published Dec. 10, 2015; (b) United States Patent Application 20140236861, entitled “Option Pricing Model For Event Driven Call and Put Options”, and published Aug. 21, 2014; (c) United States Patent Application 20140074682, entitled “Globally Optimum Trading Positions in Risk-Neutral Measure” and published Mar. 13, 2014; (d) U.S. Pat. No. 5,557,517, entitled “System and method for determining the price of an expirationless American option and issuing a buy or sell ticket on the current price and portfolio” and issued Sep. 17, 1996; (e) U.S. Pat. No. 6,061,662, entitled “Simulation method and system for the valuation of derivative financial instruments” and issued May 9, 2000, the entirety of each of which is hereby incorporated by reference herein for all purposes.

Various embodiments contemplate that any suitable model, method or computation may be used to arrive at values for Greeks.

Greeks that are Used

A system according to various embodiments may compute values for Greeks, such as for Delta, Theta, Rho, and Vega. Each of these represents a first partial derivative (i.e., “derivative” in the mathematical sense) of a value of a derivative (i.e., “derivative” in the sense of a financial security, such as a put or call) with respect to a particular variable. A system may compute values for Gamma, which represents a second partial derivative of a derivative with respect to a particular variable (i.e., the value of the underlying security).

A system according to various embodiments may also or alternatively compute values for other partial derivatives (i.e. “derivative” in the mathematical sense), for second-order partial derivatives, for third-order partial derivatives, for any order partial derivatives, for mixed partial derivatives, or for any order derivatives or other derivatives. These computed values may represent values for lesser known or unnamed “Greeks”, but may nevertheless be of interest to a user, in some embodiments.

### Process Flow

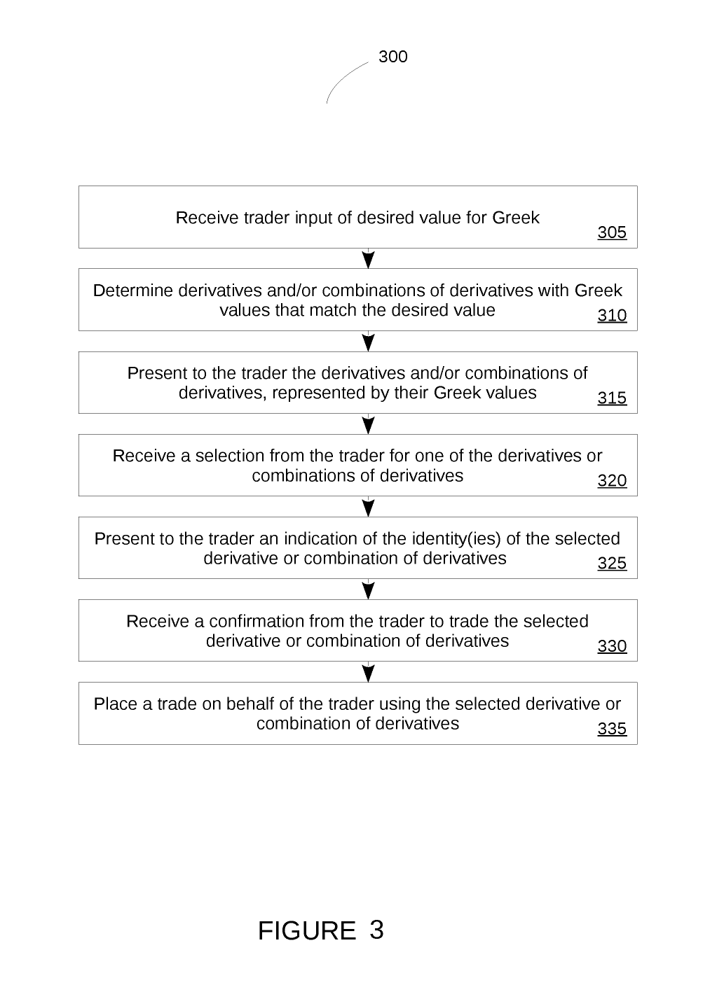

With reference to FIG. 3, a process 300 is shown according to some embodiments. At step 305, a market participant (e.g., a trader) enters a desired value for a Greek. The trader may enter a single value for a single Greek (e.g., a value of −0.5 for Delta), a range of values for a single Greek (e.g., a range of −0.6 to −0.4 for Delta), a value for each of multiple Greeks (e.g., a value of −0.5 for Delta and a value of 0.02 for Gamma), or a range of values for multiple Greeks (e.g., a range of −0.6 to −0.4 for Delta and a range of 0.015 to 0.025 for Gamma).

At step 310, the system may determine derivatives and/or combinations of derivatives with Greek values that match the desired value. In various embodiments, a match need not require exactly identical values, but may occur when two values are within a predetermined quantity, percentage, or other distance from one another. In various embodiments, the system may determine derivatives and/or combinations of derivatives whose Greek values most closely match the desired value or values entered by the trader. For example, the system may determine the 5 closest matches, the 10 closest matches, etc., according to various embodiments.

The system may determine matching derivatives and/or combinations of derivatives by reference to Greek Storage Device 115. In some embodiments, the trader device 120 queries a database of the Greek Storage Device 115 to look up derivatives that represent a match. In some embodiments, the trader device 120 determines Greek values for individual derivatives, and then calculates combinations of derivatives such that the combination would have Greek values matching the desired value. For example, the trader device may determine from the Greek Storage Device 115 that derivative X has a Delta of −0.2 and that derivative Y has a Delta of −0.3. The trader device may therefore determine that the combination of derivative X and derivative Y has a Delta of −0.5.

In various embodiments, the system must find a combination of derivatives that match on two or more Greek values. For example, a user may specify desired values for each of Delta, Gamma, Theta, and Vega. The system must then find a combination of derivatives such that the Delta for the combination matches the desired Delta, the Gamma for the combination matches the desired Gamma, the Theta for the combination matches the desired Theta, and the Vega for the desired combination has the desired Vega. As will be appreciated, if a user specifies desired values for more Greeks, then the combination will additionally need to satisfy the values of the additional Greeks.

In various embodiments, the system may determine a quantity of each derivative in a combination of derivatives. Thus, the overall Greek values for the combination may depend not only on the type of derivatives within the combination, but also on the quantity of each type of derivative. For example, if a single lot of derivative X has a Delta of 0.1, then two lots of derivative X will have a Delta of 0.2. Thus, by adjusting the quantity of each derivative, the system may more readily arrive at a desired value for one or more Greeks.

In general, if a system needs to match N desired Greek values, then the system may require N types of derivatives that are linearly independent in terms of their Greek values (i.e., if linear independence holds, the Greek values for a given derivative cannot be recreated through some linear combination of the other types of derivatives in the combination). Knowing the Greek values for each individual type of derivative, the system can solve for the quantities of each derivative required, by using standard techniques of linear algebra. For instance, suppose derivative A has Delta_A equal to 0.1, and Gamma_A equal to 0.001. Further suppose derivative B has Delta_B equal to 0.2 and Gamma_B equal to −0.001. Further, suppose the desired value for Delta is Delta_d equal to 0.5, and the desired value for Gamma is Gamma_d equal to 0.002. In this case, quantities required for derivative A (Q_A) and for derivative B (Q_B) can be solved for with the following equations:

Q_A*Delta_A+Q_B*Delta_B=Delta_d

Q_A*Gamma_A+Q_B*Gamma_B=Gamma_d

The solution of the above (e.g., using determinants, or matrix inversion) yields Q_A=3, and Q_B=1. Thus, if the user trades 3 of derivative A, and 1 of derivative B, then the user will achieve both the desired Delta and the desired Gamma.

### Determining Combinations of Derivatives

As will be appreciated, there may be many ways to search and/or select combinations of derivatives. For example, given N potential derivatives, there are N ways to select a single derivative, N*(N−1)/2 ways to select two derivatives, N*(N−1)*(N−2)/(3*2) ways to select three derivatives, and so on. Additionally, there are many ways potential quantities of each selected derivative that might be traded. For example, for a given derivative, a trader might trade 1, 5, 10, or some other quantity of the derivative. As can be seen, there are numerous ways in which derivatives might be grouped into combinations. Accordingly, in various embodiments, it may be desirable to search through the universe of potential combinations using a predefined methodology that makes desirable combinations more likely to be found quickly.

In various embodiments, the system may prioritize a search for (e.g., search first for) combinations of derivatives involving the fewest number of derivatives. The system may search for individual derivatives that have a Greek value that matches a desired value. The system may then search for pairs of derivatives that, when combined, have a combined Greek value that matches a desired value. The system may then search for groups of three derivatives that, when combined, have a combined Greek value that matches a desired value. The search may continue until a sufficient number of matching combinations have been found, until each combination contains more than a predetermined number of derivatives (e.g., more than two derivatives), and/or until some other criterion or criteria have been satisfied.

In various embodiments, the system may prioritize a search for combinations of derivatives involving the most liquid derivatives. The liquidity of a derivative may be defined in terms of one or more criteria, such as the frequency with which the derivative is traded, the bid/ask spread, the daily quantity of the derivative traded, the total number of such derivative outstanding, the historical trading volume of the derivative, the historical trading volume of similar derivatives, and/or based on any other factor or combination of factors. The system may rank derivatives according to their liquidity (e.g., from most to least liquid) and may search for combinations of derivatives with a combined Greek value starting with the most liquid derivatives, and proceeding from there to derivatives of lesser liquidity. The search may proceed until a sufficient number of combinations have been found, until all derivatives of a particular liquidity or better (e.g., more liquidity), have been found, or until some other criterion or set of criteria has been satisfied.

In some embodiments, a first subset of candidate derivatives is chosen to search through because of their respective liquidities. The system may attempt to pair up combinations of derivatives from within the first subset in order to achieve a combined value for a Greek that matches a desired value. In some embodiments, once the system has searched through the first subset of candidate derivatives, no further derivatives may be examined. In some embodiments, if an insufficient number of combinations of derivatives are found from among the first subset of candidate derivatives, then the search may be expanded to include other derivatives (e.g., to include a second subset of derivatives that are less liquid than those within the first subset). As will be appreciated, the search may be conducted, expanded, continued, etc., in various other ways, in various embodiments.

In various embodiments, the system may prioritize a search for combinations of derivatives requiring the fewest total quantities that need be traded. For example, the system may prioritize a first combination of derivatives that requires buying 2 of derivative A and selling 1 of derivative B over a second combination of derivatives that requires buying 20 of derivative C and selling 19 of derivative D.

In various embodiments, the system may prioritize a search for combinations of derivatives involving derivatives with contractual terms satisfying a user's criteria. A user's criteria may require that a selected derivative has a strike price within a defined range of strike prices, a particular strike price, an expiration date within a range of expiration dates, a particular expiration date, and/or that a derivative in a combination satisfy any other criterion or set of criteria.

In various embodiments, the system may search for combinations of derivatives using a predefined order of priorities. For example the system may first search for combinations involving less than a predefined number of derivatives. Next (e.g., if the system has not found sufficient combinations; e.g., if the system has found more combinations than necessary), the system may search for combinations involving the most liquid derivatives. Next, the system may search for combinations requiring the smallest overall quantity to be traded.

In various embodiments, the order of priorities may change. In some embodiments, a user may define the order of search priorities. For example, the user may access a menu where the user can input search priorities.

In various embodiments, the system may monitor a user's usage and may adjust search priorities accordingly. For example, if the user consistently selects combinations of derivatives that involve derivatives with a particular strike price, then the system may reprioritize its search strategy to first look at derivatives with the consistently selected strike price. As another example, if the user consistently selects combinations of derivatives requiring small overall quantities to be traded, then the system may prioritize searches for combinations of derivatives involving small overall quantities. As will be appreciated, the system may track any other user behaviour and/or stated preferences and may accordingly adjust the priority with which it searches for derivatives.

In various embodiments, the system may search for derivatives based on pre-defined criteria. In various embodiments, the system may search for derivatives based on usage data. However, in some embodiments, when a user submits preferences about which derivatives should be prioritized, the system may override the pre-defined criteria in order to search based on the user's preferences.

In various embodiments, the system may alter criteria for searching for combinations of derivatives. Criteria may be altered at various times, in various embodiments. For example, criteria may be altered before or after trading hours. In some embodiments, criteria may be altered during trading hours. In various embodiments, the system is not permitted to alter criteria when a trade is in progress (e.g., when the system is executing trades for a combination of derivatives selected by the user).

In various embodiments, characteristics of a derivative may change over time. For example, a derivative may trade more frequently just prior to the end of the trading day as compared to during the middle of the trading day. In various embodiments, the system may attempt to predict a characteristic of a derivative at a particular time, such as at a particular time in the future. The system may attempt to product a trading volume, a spread, a number of bids, a number of asks, or any other characteristic. In various embodiments, the system may search for combinations of derivatives based on predicted characteristics of the derivatives. For example, the system may search a derivative that is predicted to be especially liquid at the moment even if it has not been liquid so far during the current trading day.

In order to predict characteristics of a derivative, the system may store and/or access historical data about derivatives. The data may be stored in conjunction with time of day, day of the week, etc. In various embodiments, any potentially relevant external data may also be stored and/or accessed. External data may include values of market indices, currencies, commodities, interest rates, economic data, political data, weather data, prices of other securities, volumes of other securities, and/or any other external data.

Using historical data about the derivative the system may attempt to make predictions about its future behaviour and/or characteristics. The system may employ statistical techniques, machine learning techniques, and/or any other techniques. For example, the system may use linear regression to relate a time of day to the liquidity of a derivative. Other techniques may include neural networks, genetic algorithms, support vector machines, radial basis functions, and/or any other machine learning techniques and/or any other techniques.

In various embodiments, the system may search for derivatives based on the nature of data that is available to it. For example, in some embodiments, the system may not have consistent access to market data, or there may be a time-varying lag of the market data available to the system. The system may thus do a first type of search if a first type of data is available to it, and a second type of search if a second type of data is available to it. For example, if the system has access to market data with less than a 10 millisecond lag, the system may do a first type of search, whereas if the system has access to market data with a greater than 10 millisecond lag, the system may do a second type of search. The first type of search may be for combinations of derivatives each having pre-defined strike prices, whereas the second type of search may be for combinations of derivatives involving the fewest different types of derivatives.

### Matches Presented to Trader

At step 315, the system may present to the trader the matches. The matches may be presented as buttons that the trader can easily press to select a corresponding match. As will be appreciated, the matches may be presented in any other suitable form, and may be selected in any suitable manner. In various embodiments, matches may be presented such that each match is represented by its Greek values. Thus, for example, the trader may be presented with a list of five matches labelled as follows: (1) Delta −0.48; (2) Delta −0.53; (3) Delta −0.55; (4) Delta −0.44; (5) Delta −0.57. Of course, the word “Delta” may be omitted (e.g., it may be assumed the trader knows the figures represent a Delta, etc.), values may be represented in other way, additional information may be displayed, and/or matches may be presented in any other suitable manner.

In various embodiments, the list of matches may be dynamic, and may update periodically and/or continuously. For example, if the trader takes some time to make his selection, market circumstances might change (e.g., new transactions may occur at different prices), and accordingly values for one or more Greeks might change. In such cases, the system may update the list of matches presented to the trader. Updates may, for example, cause the addition or removal of certain matches from the initial list, may result in a reordering of the list, and/or may result in different values being displayed for Greeks.

At step 320, the trader selects one of the matches. For example, the trader touches an appropriate area on his touch screen, clicks an appropriate area with his mouse, etc.

At step 325, the system presents to the trader an indication of the identity or identities of the selected derivative or combination of derivatives that the trader has selected. For example, if the trader has selected a match listed simply as “Delta −0.48”, the trader may now be shown that the match is a put option with a strike price of 10 and an expiration date of June, 2020.

At step 330, the trader has the opportunity to confirm that he stands by his original selection now that he knows the identity of the derivative and/or combination of derivatives. The trader may, for example, press an “I agree” or similarly labelled button. In some cases, trader may decide not to proceed with his selection, and may return to an earlier step, where he may make a different selection, or may even enter new values for Greeks. To return to an earlier step, a trader may press “Back” or similar button, for example.

At step 335, the trader has confirmed his initial selection, and the system may place a trade or trades on behalf of the trader for the selected derivative and/or combination of derivatives. Following confirmation, the trader device may send an indication of the desired trade(s) to the Clearer/Execution Broker Server 125, whereupon the Server 125 may place the trade(s) with Exchange Server 105.

In various embodiments, a trader may receive a confirmation once the trade(s) has been successfully completed.

As will be appreciated, the foregoing steps represent a process according to some embodiments, but various embodiments contemplate that more or fewer process steps may be performed, that process steps may be performed in a different order, that substitute process steps might be performed, that certain steps would be repeated more than one time, and/or that any other alternative process flow might occur.

In various embodiments, a trader need not initially enter a desired value for one or more Greeks. Rather, the trader may be presented with a number of available derivatives (and/or combinations of derivatives) that are represented and/or prominently identified by their values for Greeks. The derivatives may be sorted in one or more ways. For example, the derivatives may be sorted by their values for Delta. Accordingly, if the trader has a desired value for a Greek in mind, the trader may readily select a corresponding derivative by scanning the list of available derivatives and choosing the closest matching derivative.

In various embodiments, a trader may first indicate a trade he is contemplating. The trader may, for instance, enter the names of one or more derivatives, “buy” or “sell”, the desired price, etc. At this point, the system may show to the trader one or more Greek values associated with the contemplated derivatives. In some embodiments, the trader device 120 polls the Greek Storage Device 115 to look up the Greek values associated with the contemplated derivatives, and then displays such Greek values on the display of the trader device 120. Similarly, in various embodiments, if the trader is contemplating a trade involving multiple derivatives, the system may look up Greek values for each individual derivative and calculate aggregate Greek values for the whole trade based on the individual Greek values.

In various embodiments, a trader wishes to monitor one or more derivatives. The trader may configure the trader device 120 to display information associated with the derivatives. Such information may be regularly updated, corresponding to changes in market conditions, transactions in the market, etc. Information shown about the derivatives on the trader device 120 may include values for associated Greeks. In various embodiments, a derivative that a trader is monitoring may appear exclusively or prominently in the form of a value of an associated Greek. That is, for example, rather than listing a derivative in the form of a strike price and expiration date, the trader device may list the derivative in the form of a Delta, Vega, Theta, and/or Gamma, etc.

In various embodiments, a trader may have a toggle switch that allows the trader to switch back and forth between a traditional listing of derivatives, and a listing in terms of Greek values.

### Trading Combinations of Derivatives

In various embodiments, a trader may decide he wishes to execute a trade involving a combination (i.e., two or more) of derivatives. For example, the aggregate Greek values for all the derivatives in the combination might equal desired Greek values that the trader hopes to achieve by making a trade.

However, in various embodiments, there may be a possibility that some of the derivatives in the combination would get traded, and others would not. This may occur for example, if counter-parties to the desired trade do not materialize, or market conditions change as the trader is trying to execute the trade. Where only some of a trade or trades from a desired trade or set of trades gets executed, this may be referred to as a “partial fill”.

A partial fill may present problems for a trader in that the completed trades will not necessarily achieve the Greek values desired by the trader. This is because, Greek values for individual or sub-combinations of derivatives will not necessarily equal Greek values for the entire combination.

Accordingly, in various embodiments, the system may take one or more measures to ascertain the likelihood of a trade being fulfilled. The system may determine the likelihood that the trade of each derivative in a combination of derivatives would be fulfilled.

In some embodiments, the system determines the liquidity of the market for a particular derivative. The liquidity may be determined as the frequency and/or volume with which the derivative is traded, the frequency and/or volume with which the derivative has been traded in the most recent time period (e.g., in the most recent hour, e.g., in the most recent day), the number of outstanding similar derivative contracts, the market capitalization of the underlying security or securities, the bid-ask spread, the current number of bids and/or asks, or any other measure. The liquidity may be determined as any other suitable metric.

In some embodiments, the system may ascertain the likelihood of a trade being filled based on the liquidity of the market for the derivative or combination of derivatives to be traded. The system may present the trade as a possibility for the trader only if the likelihood exceeds a predetermined value. In some embodiments, a trade may be presented as a possibility to a trader only if the liquidity for each derivative involved in the trade exceeds a predetermined value (e.g., if more than 10,000 of each derivative contract has been traded in the most recent day).

In some embodiments, the system presents to a trader an indication of the liquidity of a derivative or combination of derivatives for which the trader is contemplating a trade. The trader may then decide for himself whether or not he would like to attempt the trade based on the liquidity indicators.

In some embodiments, once a trader has confirmed his/her desire to make a trade involving a combination of derivatives, the system may attempt to execute the trades of each individual derivative in a particular order that is designed to minimize any deviations in Greek values that might result from a partial fill. For example, suppose a trader desires to make a trade so as to achieve a Delta of 0.2. The trader agrees to a trade of a combination of derivatives with Deltas as follows: −0.3, 0.1, 0.4. The system may first attempt to trade the derivative with Delta of 0.1, since, if the system is unable to trade the other two derivatives, the resultant Delta for the trade will be 0.1, which is only 0.1 off the desired Delta. On the other hand, were the system to trade the derivative with Delta of −0.3 first, and be unable to trade the other two derivatives, then the Delta for the entire trade would be off by 0.5.

### Application Programming Interface

In various embodiments, a module may be dedicated to displaying derivatives in terms of corresponding Greek values. In various embodiments, the module may further include receiving requests for trades of such derivatives from traders. The module may interface to a traditional trading module or platform. For example, the module may act as an overlay.

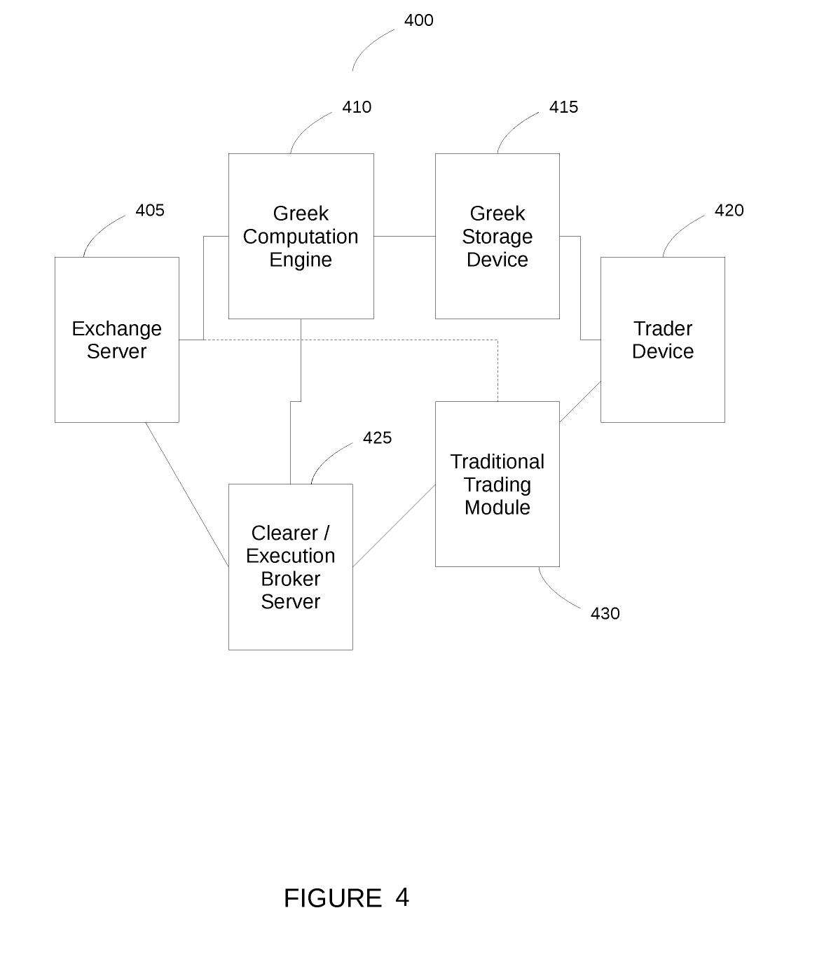

With reference to FIG. 4, a system 400 is shown according to some embodiments. A subset of system 400 may be viewed as a traditional trading system, platform, or setup. The Exchange Server 405 may communicate directly with a Traditional Trading Module 430, and may provide market data to Module 430. The Traditional Trading Module 430 may be a software program, hardware device, and/or combination hardware software device that allows a trader to view traditional market data (e.g., current prices for derivatives of interest), and to initiate trades. Once the Traditional Trading Module 430 receives instructions from a trader to place a trade, these instructions may be relayed to Clearer/Execution Broker Server 425, which may then place the trade with the Exchange Server 405 on behalf of the trader.

According to various embodiments, additional components/modules may be implemented in order to allow a trader to obtain certain benefits described herein. The Trader Device 420 may be a software program, hardware device, and/or combination hardware software device that displays information to a trader (e.g., the values of Greeks for various derivatives). The Trader Device 420 may obtain such information from Greek Computation Engine 410 and/or from Greek Storage Device 415. The Trader Device 420 may also receive instructions from a trader to place a trade. The instructions might be created, for example, when a trader presses a button on the Trader Device to buy or sell a particular derivative or combination of derivatives.

The Trader Device 420 may then relay such instructions to the Traditional Trading Module 430. As the Trader Device 420 may be, or may be running a standalone software program (e.g., a software program that is separate from any software associated with the Traditional Trading Module 430), the Trader Device 420 may communicate with the Traditional Trading Module 430 via an Applications Programming Interface (API).

The Traditional Trading Module 430 may also relay information back to the Trader Device 420, such as information about whether or not trades have successfully executed.

In various embodiments, the Traditional Trading Module 430 may be a software program running on the Trader Device. Thus, various embodiments provide an additional software layer that resides on the same device as the Traditional Trading Module, and provides extra information (e.g., values for Greeks) and/or interface options for the user (e.g., the ability to select derivatives according to their Greek values). In such embodiments, an additional software layer stands between the trader and the Traditional Trading Module. In various embodiments, the Traditional Trading Module need not operate in a fashion significantly different than that for which it was initially created. Instead of receiving trade instructions from a trader, the Traditional Trading Module receives instructions from the intermediary software layer.

### Embodiments

The following are embodiments, not claims:
In various embodiments, there may be displayed for the user derivatives matching a target Greek value. In various embodiments, the derivatives may be displayed in such a way that Greek values associated with the derivatives may be displayed prominently. In various embodiments, the derivatives may be displayed leading with their associated Greek values.
A. A device comprising:

an input module;

an output module;

a communications port;

a memory storing computer instructions;

a processor that executes the computer instructions to:
receive contractual terms defining a financial derivative;
receive market data about the financial derivative;
determine a first value of the financial derivative;
determine a variable that influences the first value of the financial derivative;
determine, based on the contractual terms and based on the market data, a second value of a Greek parameter, in which the second value represents a rate of change in the first value of the financial derivative with respect to the variable;
determine a target value of the Greek parameter;
determine that the second value of the Greek parameter matches the target value of the Greek parameter;
cause, in response to the determination that the second value matches the target value, identifying information for the financial derivative to be displayed to a user, in which the identifying information begins with indicia indicative of the second value;
receive from the user a selection of the financial derivative for trading; and
cause a trade of the financial derivative to be executed on behalf of the user.
   A.1 The device of embodiment A in which contractual terms include one or more of: (a) a definition of an underlying financial security; (b) a strike price; (c) an expiration date; (d) a right to buy the underlying financial security; (e) a right to sell the underlying financial security; and (f) a right to act prior to the expiration date.
   A.2 The device of embodiment A in which market data includes historical prices at which the derivative was bought and sold.
   A.9 The device of embodiment A in which the first value is a market price of the financial derivative.
   In various embodiments, the first value is a theoretical price of the financial derivative. This theoretical price may be a price derived from a theoretical model, such as from Black-Scholes, etc.
   A.10 The device of embodiment A in which the first value is a theoretical price of the financial derivative.
   A.3 The device of embodiment A in which the variable is one of: (a) a price of an underlying financial security; (b) an amount of time remaining during which one or more contractual terms may be exercised; (c) an interest rate; and (d) a volatility of an underlying security.
   In various embodiments, after the user selects a financial derivative, the user may be shown further information (e.g., about the derivative) to make sure the derivative is acceptable to the user.
   A.4 The device of embodiment A in which the processor executes the computer instructions to further:

cause, in response to the user selection of the financial derivative for trading, a confirmation request to be displayed to the user, in which the confirmation request asks the user to confirm that the user wishes to trade the selected financial derivative; and

receive a confirmation from the user.

In various embodiments, when the user is shown further information about a selected derivative, the user can then confirm the selection by viewing traditional contract terms of an derivative, such as strike price, expiration date, etc.
A.4.1 The device of embodiment A.4 in which the confirmation request further includes an indication of a subset of the contractual terms defining the financial derivative.
A.5 The device of embodiment A in which the variable is a price of an underlying security and in which the Greek parameter is Delta.
A.6 The device of embodiment A in which, in determining the target value of the Greek parameter, the processor executes instructions to:

receive from the user an indication of the target value of the Greek parameter.

In various embodiments, the target value is what is needed to hedge a set of securities (e.g., derivatives, stocks, etc.) already controlled by the user.
A.7 The device of embodiment A in which, in determining the target value of the Greek parameter, the processor executes instructions to:

determine a set of securities controlled by the user;

determine a third value of the Greek parameter associated with the set of securities; and

determining the target value as the negative of the third value.

A.7.1 The device of embodiment A.7 in which, in determining the third value of the Greek parameter associated with the set of securities, the processor executes instructions to:

determine a fourth value representing an aggregate value of the set of securities; and

determine the third value as the rate of change of the fourth value with respect to the variable.

In various embodiments, when there is a match of a Greek parameter to the target value, the match need only be approximate. For example, a match may occur if the second value of the Greek parameter is within a predetermined percentage, a predetermined absolute amount, a predetermined multiple, and/or within some other relation to the target value.
A.8 The device of embodiment A in which, in determining that the second value of the Greek parameter matches the target value of the Greek parameter, the processor executes instructions to:

determine that the second value of the Greek parameter differs by less than a predetermined amount from the target value of the Greek parameter.

In various embodiments, a combination of derivatives is determined, in which the combination matches a target value.
B. A device comprising:

an input module;

an output module;

a communications port;

a memory storing computer instructions;

a processor that executes the computer instructions to:
identify a plurality of financial derivatives;
receive respective contractual terms for each of the plurality of financial derivatives;
receive respective market data about each of the plurality of financial derivatives;
determine a respective first value for each of the plurality of financial derivatives;
determine a variable that influences each of the respective first values of the financial derivatives;
determine, based on the respective contractual terms and based on the respective market data for each of the plurality of financial derivatives, a second value of a Greek parameter for each of the plurality of financial derivatives, in which the second value for a given financial derivative represents a rate of change in the first value for the given financial derivative with respect to the variable;
determine a target value of the Greek parameter;
determine a first subset of the plurality of financial derivatives;
determine a first summation of the respective second values of the Greek parameter over the first subset of the plurality of financial derivatives;
determine that the first summation matches the target value of the Greek parameter;
cause, in response to the determination that the first summation matches the target value, identifying information for the first subset of the plurality of financial derivatives to be displayed to a user;
receive from the user a selection of the first subset of the plurality of financial derivatives for trading; and
execute a respective trade for each of the first subset of the plurality of financial derivatives on behalf of the user.
   B.1 The device of embodiment B, in which, in causing identifying information for the first subset of the plurality of financial derivatives to be displayed to the user, the processor executes instructions to:

cause identifying information for the first subset of the plurality of financial derivatives to be displayed to the user beginning with indicia indicative of the first summation.

B.2 The device of embodiment B, in which the processor executes instructions to further:

determine a second subset of the plurality of financial derivatives;

determine a second summation of the respective second values of the Greek parameter over the second subset of the plurality of financial derivatives;

determine that the second summation matches the target value of the Greek parameter;

cause, in response to the determination that the second summation matches the target value, identifying information for the second subset of the plurality of financial derivatives to be displayed to the user.

In various embodiments, combinations of derivatives may be tested which turn out not to match the target value specified by the user. Such combinations may not be displayed to the user.
B.3 The device of embodiment B, in which the processor executes instructions to further:

determine a third subset of the plurality of financial derivatives;

determine a third summation of the respective second values of the Greek parameter over the third subset of the plurality of financial derivatives; and

determine that the third summation does not match the target value of the Greek parameter.

In various embodiments, a user may be shown information about each derivative in a matching combination. For example, the user may be shown contractual terms for each of three derivatives within a combination.
B.4 The device of embodiment B, in which, in causing identifying information for the first subset of the plurality of financial derivatives to be displayed to the user, the processor executes instructions to:

cause identifying information for each derivative within the first subset of the plurality of financial derivatives to be displayed to the user.

B.5 The device of embodiment B, in which, in determining a first subset of the plurality of financial derivatives, the processor executes instructions to:

firstly iterate through each of the derivatives individually from within the plurality of derivatives; and

secondly iterate through each combination of two derivatives from within the plurality of derivatives.

B.5.1 The device of embodiment B.5, in which, in determining a first subset of the plurality of financial derivatives, the processor executes instructions to further:

thirdly iterate through each combination of three derivatives from within the plurality of derivatives.

B.6 The device of embodiment B, in which, in determining a first subset of the plurality of financial derivatives, the processor executes instructions to:

firstly determine a second subset of the plurality of financial derivatives, the second subset including the most liquid of the plurality of financial derivatives; and

secondly select the first subset from the second subset.

B.7 The device of embodiment B, in which, in determining a first subset of the plurality of financial derivatives, the processor executes instructions to:

firstly determine a second subset of the plurality of financial derivatives, the second subset including financial derivatives with expiration dates falling within a predetermined time period; and

secondly select the first subset from the second subset.

B.8 The device of embodiment B, in which, in determining a first subset of the plurality of financial derivatives, the processor executes instructions to:

firstly determine a second subset of the plurality of financial derivatives, the second subset including financial derivatives each of which has an associated value of the Greek parameter that exceeds a predetermined threshold value; and

secondly select the first subset from the second subset.

The foregoing descriptions, depictions, and illustrations represent some embodiments, but it will appreciated that contemplated embodiments are not limited to those explicitly described herein, and may include embodiments falling within the spirit and/or scope of those described herein.

1. A device comprising:
an input module;
an output module;
a communications port;
a memory storing computer instructions;
a processor that executes the computer instructions to:
receive contractual terms defining a financial derivative;
receive market data about the financial derivative;
determine a first value of the financial derivative;
determine a variable that influences the first value of the financial derivative;
determine, based on the contractual terms and based on the market data, a second value of a Greek parameter, in which the second value represents a rate of change in the first value of the financial derivative with respect to the variable;
determine a target value of the Greek parameter;
determine that the second value of the Greek parameter matches the target value of the Greek parameter;
cause, in response to the determination that the second value matches the target value, identifying information for the financial derivative to be displayed to a user, in which the identifying information begins with indicia indicative of the second value;
receive from the user a selection of the financial derivative for trading; and
cause a trade of the financial derivative to be executed on behalf of the user.

2. The device of claim 1 in which contractual terms include one or more of: (a) a definition of an underlying financial security; (b) a strike price; (c) an expiration date; (d) a right to buy the underlying financial security; (e) a right to sell the underlying financial security; and (f) a right to act prior to the expiration date.

3. The device of claim 1 in which market data includes historical prices at which the derivative was bought and sold.

4. The device of claim 1 in which the first value is a market price of the financial derivative.

5. The device of claim 1 in which the variable is one of: (a) a price of an underlying financial security; (b) an amount of time remaining during which one or more contractual terms may be exercised; (c) an interest rate; and (d) a volatility of an underlying security.

6. The device of claim 1 in which the processor executes the computer instructions to further:
cause, in response to the user selection of the financial derivative for trading, a confirmation request to be displayed to the user, in which the confirmation request asks the user to confirm that the user wishes to trade the selected financial derivative; and
receive a confirmation from the user.

7. The device of claim 6 in which the confirmation request further includes an indication of a subset of the contractual terms defining the financial derivative.

8. The device of claim 1 in which the variable is a price of an underlying security and in which the Greek parameter is Delta.

9. The device of claim 1 in which, in determining the target value of the Greek parameter, the processor executes instructions to:
receive from the user an indication of the target value of the Greek parameter.

10. The device of claim 1 in which, in determining the target value of the Greek parameter, the processor executes instructions to:
determine a set of securities controlled by the user;
determine a third value of the Greek parameter associated with the set of securities; and
determining the target value as the negative of the third value.

11. The device of claim 10 in which, in determining the third value of the Greek parameter associated with the set of securities, the processor executes instructions to:
determine a fourth value representing an aggregate value of the set of securities; and
determine the third value as the rate of change of the fourth value with respect to the variable.

12. The device of claim 1 in which, in determining that the second value of the Greek parameter matches the target value of the Greek parameter, the processor executes instructions to:
determine that the second value of the Greek parameter differs by less than a predetermined amount from the target value of the Greek parameter.

13. A device comprising:
an input module;
an output module;
a communications port;
a memory storing computer instructions;
a processor that executes the computer instructions to:
identify a plurality of financial derivatives;
receive respective contractual terms for each of the plurality of financial derivatives;
receive respective market data about each of the plurality of financial derivatives;
determine a respective first value for each of the plurality of financial derivatives;
determine a variable that influences each of the respective first values of the financial derivatives;
determine, based on the respective contractual terms and based on the respective market data for each of the plurality of financial derivatives, a second value of a Greek parameter for each of the plurality of financial derivatives, in which the second value for a given financial derivative represents a rate of change in the first value for the given financial derivative with respect to the variable;
determine a target value of the Greek parameter;
determine a first subset of the plurality of financial derivatives;
determine a first summation of the respective second values of the Greek parameter over the first subset of the plurality of financial derivatives;
determine that the first summation matches the target value of the Greek parameter;
cause, in response to the determination that the first summation matches the target value, identifying information for the first subset of the plurality of financial derivatives to be displayed to a user;
receive from the user a selection of the first subset of the plurality of financial derivatives for trading; and
execute a respective trade for each of the first subset of the plurality of financial derivatives on behalf of the user.

14. The device of claim 13, in which, in causing identifying information for the first subset of the plurality of financial derivatives to be displayed to the user, the processor executes instructions to:
cause identifying information for the first subset of the plurality of financial derivatives to be displayed to the user beginning with indicia indicative of the first summation.

15. The device of claim 13, in which the processor executes instructions to further:
determine a second subset of the plurality of financial derivatives;
determine a second summation of the respective second values of the Greek parameter over the second subset of the plurality of financial derivatives;
determine that the second summation matches the target value of the Greek parameter;
cause, in response to the determination that the second summation matches the target value, identifying information for the second subset of the plurality of financial derivatives to be displayed to the user.

16. The device of claim 13, in which, in causing identifying information for the first subset of the plurality of financial derivatives to be displayed to the user, the processor executes instructions to:
cause identifying information for each derivative within the first subset of the plurality of financial derivatives to be displayed to the user.

17. The device of claim 13, in which, in determining a first subset of the plurality of financial derivatives, the processor executes instructions to:
firstly iterate through each of the derivatives individually from within the plurality of derivatives; and
secondly iterate through each combination of two derivatives from within the plurality of derivatives.

18. The device of claim 13, in which, in determining a first subset of the plurality of financial derivatives, the processor executes instructions to:
firstly determine a second subset of the plurality of financial derivatives, the second subset including the most liquid of the plurality of financial derivatives; and
secondly select the first subset from the second subset.

19. The device of claim 13, in which, in determining a first subset of the plurality of financial derivatives, the processor executes instructions to:
firstly determine a second subset of the plurality of financial derivatives, the second subset including financial derivatives with expiration dates falling within a predetermined time period; and
secondly select the first subset from the second subset.

20. The device of claim 13, in which, in determining a first subset of the plurality of financial derivatives, the processor executes instructions to:
firstly determine a second subset of the plurality of financial derivatives, the second subset including financial derivatives each of which has an associated value of the Greek parameter that exceeds a predetermined threshold value; and
secondly select the first subset from the second subset.
